(19) United States
(12) Patent Application Publication
(10) Pub. No.: US 2015/0285454 A1
(43) Pub. Date: Oct. 8, 2015

(54) Dynamic Light Control System And Methods For Producing The Same

(71) Applicant: PRESIDENT AND FELLOWS OF HARVARD COLLEGE, Cambridge, MA (US)

(72) Inventors: Joanna Aizenberg, Boston, MA (US); Allen Sayegh, Cambridge, MA (US); Timur Dogan, Rossdorf (DE); Christian Ervin, Lake Oswego, OR (US); Kiel Kenneth Moe, Cambridge, MA (US); Jack Alvarenga, Quincy, MA (US); Martin Bechthold, Cambridge, MA (US); Benjamin Hatton, Toronto (CA); Philseok Kim, Arlington, MA (US); Daekwon Park, Cambridge, MA (US)

(21) Appl. No.: 14/443,170

(22) PCT Filed: Nov. 18, 2013
(86) PCT No.: PCT/US2013/070622

§ 371 Date: May 15, 2015

Related U.S. Application Data
(60) Provisional application No. 61/727,543, filed on Nov. 16, 2012.

(51) Int. Cl. F21S 11/00; G02B 26/08; G02B 26/00

(52) U.S. Cl. CPC F21S 11/007; G02B 26/004; G02B 26/08

(57) ABSTRACT

The present application describes dynamic light control system that, can dynamically adapt to different sun positions and interior lighting levels. The dynamic light control system, includes two or more confinement panes and one or more light redirecting elements positioned therebetween. The light redirecting elements are arranged to deform the light redirecting elements in response to a change in the position of the sun. In addition, one or more fluidic-channels are formed between the light redirecting elements and the confinement panels, that can be filled with any desired fluid to provide additional dynamic changes depending on the desired characteristics.

### COPYRIGHT NOTICE

This patent disclosure may contain material that is subject to copyright protection. The copyright owner has no objection to the facsimile reproduction by anyone of the patent document or the patent disclosure as it appears in the U.S. Patent and Trademark Office patent file or records, but otherwise reserves any and all copyright rights.

### INCORPORATION BY REFERENCE

All patents, patent applications and publications cited herein are hereby incorporated by reference in their entirety in order to more fully describe the state of the art as known to those skilled therein as of the date of the invention described herein.

### CROSS-REFERENCE TO RELATED APPLICATIONS

The present application claims the benefit of the earlier filing date of U.S. Patent Application No. 61/727,543, filed on Nov. 16, 2012, the contents of which are incorporated by reference herein in its entirety.

### FIELD OF THE INVENTION

The present application relates to light redirection and control systems that can dynamically adapt to different sun positions and interior lighting levels.

### BACKGROUND

Daylighting in buildings is directly linked to resource efficiency, quality of space and health of the occupants. Compared with artificial lighting, daylighting provides an ideal color rendering environment, as well as positive stimulating psychological and physiological effects on the occupants. Moreover, around 40% of the total energy demand in the United States is caused by buildings. Heating and cooling loads are obviously also greatly influenced by solar radiation. Therefore, a smart use of the sun as a free local energy source in architecture becomes more and more important in times of high energy prices and fossil fuel scarcity. Consequently, improving daylight performance of buildings provides opportunity for any climate change mitigation efforts as well as attempts to improve inhabitants' health and quality of life.

One approach to improve the daylight performance of buildings is to optimize light propagation. Architectural elements such as light shelves, blinds and louvers as well as prismatic glazing systems such as LCP's (Laser Cut Panels) are fairly low-tech solutions. Their operation usually follows a similar concept: a fraction of the light that arrives at the façade of the building is redirected to the interior ceiling. This redirection allows light to travel deeper into the space to areas of the interior that otherwise would not receive natural light and helps to improve daylight performance and quality in two ways. The secondary bounce of the sunlight from the ceiling improves daylight autonomy of the areas with a certain distance to the façade. An additional benefit is that the redirection of light reduces the possibility of excess sunlight in the near façade area. Excess sunlight can lead to discomfort through glare and localized heating. A response to glare usually is the use of a blind system that however further reduces the daylight illumination of the entire space.

Despite all the benefits of daylight performance enhancing devices, they are often not implemented since they drastically influence the design of a building due to their size and added extra cost to the construction bill. In addition these systems also generate follow-up costs due to complicated maintenance. For example, exterior mounted dynamic and retractable systems are very sensitive to wind and dirt. Moveable blinds often have to be controlled by wind speed sensors in order for motors to retract the system at high wind speeds.

Integrated systems such as small louvers that reside in the cavity of a double glazed façade are more robust. However, these systems are usually static, do not respond to the changing position of the sun and therefore have a lower efficiency, and permanently obstruct views. Consequently, a minimalistic and simple solution that can dynamically adjust the redirection angle, the degree of diffuse and direct transmission and visual transparency of the glazing is very interesting for the new construction as well as the retrofit market.

### SUMMARY

In accordance with certain embodiments, a dynamic light control system is described. The dynamic light control system can include two or more confinement panes; one or more light redirecting elements positioned between said two or more confinement panes, wherein said light redirecting elements include a deformable material; one or more fluidic channels formed between said plurality of light redirecting elements and said two or more confining panes; wherein said one or more light redirecting elements are arranged to deform relative to the position of said two or more confinement panes in response to one or more stimuli to allow redirection of light.

In accordance with certain embodiments, a method for redirecting light from a source is described. The method can include providing two or more confinement panes; providing one or more light redirecting elements positioned between said two or more confinement panes, wherein said light redirecting elements include a deformable material and wherein one or more fluidic channels are formed between said one or more light redirecting elements and said two or more confinement panes; and deforming said one or more light redirecting elements relative to the two or more confinement panes to redirect light.

In certain embodiments, the method further includes inputting or removing a fluid into or out of said one or more fluidic channels.

In certain embodiments, the method further includes deforming one or more of said confinement panes.

In certain embodiments, the method further includes deforming one or more of said one or more light redirecting elements.

In accordance with certain embodiments, a method of producing a dynamic light control system is described. The method can include providing two or more confinement panes; providing one or more light redirecting elements between said two or more confinement panes to form one or more fluidic channels between said one or more light redirecting elements, wherein said light redirecting elements include a deformable material; and arranging said one or more light redirecting elements to deform relative to the position of said two or more confinement panes in response to one or more stimuli to account for a change in the direction of the incident light.

In certain embodiments, said providing a plurality of light redirecting elements includes shaping and arranging said plurality of light redirecting elements to function as a light reflector.

In certain embodiments, said providing a plurality of light redirecting elements includes shaping and arranging said plurality of light redirecting elements to function as a waveguide.

In certain embodiments, said providing a plurality of light redirecting elements includes shaping and arranging said plurality of light redirecting elements to function as a light scatterer or diffuser.

In accordance with certain embodiments, the dynamic light control system can further include a fluid flow mechanism capable of inputting and removing fluid into and out of said one or more fluidic channels.

In accordance with certain embodiments, said one or more light redirecting elements are transparent in the bulk state.

In accordance with certain embodiments, said one or more light redirecting elements have an index of refraction that is about 1.2 to about 1.8.

In accordance with certain embodiments, the thickness of the light redirecting elements ranges from about 10 μm to about 2 mm.

In accordance with certain embodiments, the aspect ratio of the light redirecting elements range from about 1 to 20.

In accordance with certain embodiments, the light redirecting elements are shaped and arranged to function as a light reflector.

In accordance with certain embodiments, the light redirecting elements are shaped and arranged to function as a waveguide.

In accordance with certain embodiments, the light redirecting elements are shaped and arranged to function as a light scatterer or diffuser.

In accordance with certain embodiments, said one or more fluidic channels includes a fluid.

In accordance with certain embodiments, the fluid is a liquid.

In accordance with certain embodiments, the fluid is a gas.

In accordance with certain embodiments, the fluid has an index of refraction that is about the same as the index of refraction of the light redirecting elements.

In accordance with certain embodiments, the fluid includes scattering centers, coloring agents, absorbers, reflectors, or combinations thereof.

In accordance with certain embodiments, said confinement panes are selected from at least one of a glazing pane, a transparent pane, a translucent pane, a non-transparent pane having one or more transparent or translucent regions, or a pane having one or more cutouts.

In accordance with certain embodiments, one or more of said confinement panes are arranged to deform in response to said one or more stimuli.

In accordance with certain embodiments, said fluid flow mechanism includes a pump, an inlet and an outlet connected to at least a part of said one or more fluidic channels.

In accordance with certain embodiments, said fluid flow mechanism inputs a fluid into said one or more fluidic channels to deform said one or more light redirecting elements.

In accordance with certain embodiments, said light redirecting elements include two or more regions having different mechanical or optical properties and respond differently to said one or more stimuli.

In accordance with certain embodiments, said light redirecting elements include stimuli-responsive material.

### BRIEF DESCRIPTION OF THE DRAWINGS

The above and other objects and advantages of the present invention will be apparent upon consideration of the following detailed description, taken in conjunction with the accompanying drawings, in which like reference characters refer to like parts throughout, and in which:

FIG. 1A shows a diagram of a typical daylight level distribution using clear glass window within a typical office space and targeted light levels that can be achieved using the dynamic light control system in accordance with certain embodiments;

FIG. 1B shows a diagram of an interior room space showing a desired light redirection property in accordance with certain embodiments;

FIGS. 2A and 2B show diagrams of exemplary dynamic light control system in accordance with certain embodiments;

FIG. 2C shows three different states of a dynamic light control system and their functions in accordance with certain embodiments: (left) light redirection effect from empty fluidic channels by specular reflection and total internal reflection, (middle) clear transparent glazing with fully or partially index matched fluid filled in the fluidic channels, and (right) diffusive/absorbing/dimming/coloring effect with particle suspended or pigmented fluid filled in the fluidic channels;

FIG. 2D shows light ray trace studies through the dynamic light control system as a function at different angles of incidence of light to the light redirecting elements in accordance with certain embodiments;

FIG. 3 shows exemplary dynamic light control systems having light shelf characteristics in accordance with certain embodiments;

FIG. 4 shows additional exemplary dynamic light control systems having waveguiding characteristics in accordance with certain embodiments;

FIG. 5 shows exemplary dynamic light control systems in accordance with certain embodiments;

FIG. 6 show additional exemplary dynamic light control systems in accordance with certain embodiments;

FIG. 7 shows exemplary helical dynamic light control system in accordance with certain embodiments;

FIGS. 8A-8F show exemplary dynamic light control system with various different fluids filled in the fluidic channels in accordance with certain embodiments;

FIG. 9 shows an exemplary dynamic light control system with two different fluids filled in the two different fluidic channels in accordance with certain embodiments;

FIGS. 10A-10D show exemplary dynamic light control systems with two different fluids filled in a single fluidic channel in accordance with certain embodiments;

FIG. 11A shows an exemplary deformation of the light redirecting elements using finite element modeling in the dynamic light control system in accordance with certain embodiments;

FIGS. 11B-11K show exemplary deformations of the light redirecting elements in the dynamic light control system in accordance with certain embodiments;

FIGS. 12A-12C show exemplary deformation mechanism that can be provided to the dynamic light control system in accordance with certain embodiments;

FIG. 13 shows some existing daylight control systems as compared to the dynamic light control systems that are in accordance with certain embodiments;

FIGS. 14A and 14B show some digital models of molds used for the production of the dynamic light control systems in accordance with certain embodiments;

FIGS. 15A and 15B show masters utilized to form light redirecting elements in accordance with certain embodiments;

FIGS. 16A and 16B show light redirecting elements formed using the masters shown in FIGS. 15A and 15B in accordance with certain embodiments;

FIG. 17A shows a schematic illustration of attachment of the light redirection elements to glass panes in accordance with certain embodiments;

FIGS. 17B and 17C show dynamic light control system produced using the light redirecting elements shown in FIGS. 16A and 16B in accordance with certain embodiments;

FIGS. 18A and 18B show the shear deformation studies of the dynamic light control system in accordance with certain embodiments;

FIG. 19 shows a qualitative light redirection performance of the produced dynamic light control system in accordance with certain embodiments;

FIG. 20 shows a schematic illustration of a white-box light redirection test in accordance with certain embodiments;

FIGS. 21A-21F show the white-box light redirection test results in accordance with certain embodiments;

FIG. 22A shows a schematic illustration of a black-box light redirection test in accordance with certain embodiments;

FIGS. 22B-22D show experimental data on light intensity change generated by the produced dynamic light control system in accordance with certain embodiments;

FIG. 23A shows a schematic illustration of a shoebox light redirection test in accordance with certain embodiments;

FIG. 23B shows a plot of shoebox light redirection test showing improved illumination of the dynamic light control system to further distances compared to conventional systems in accordance with certain embodiments;

FIGS. 24A-24C shows a dynamic light control system partially or completely filled with an index-matching fluid in accordance with certain embodiments; and

FIGS. 25A-25F show an illustrative method of fabricating the dynamic light control system in accordance with certain embodiments.

### DETAILED DESCRIPTION

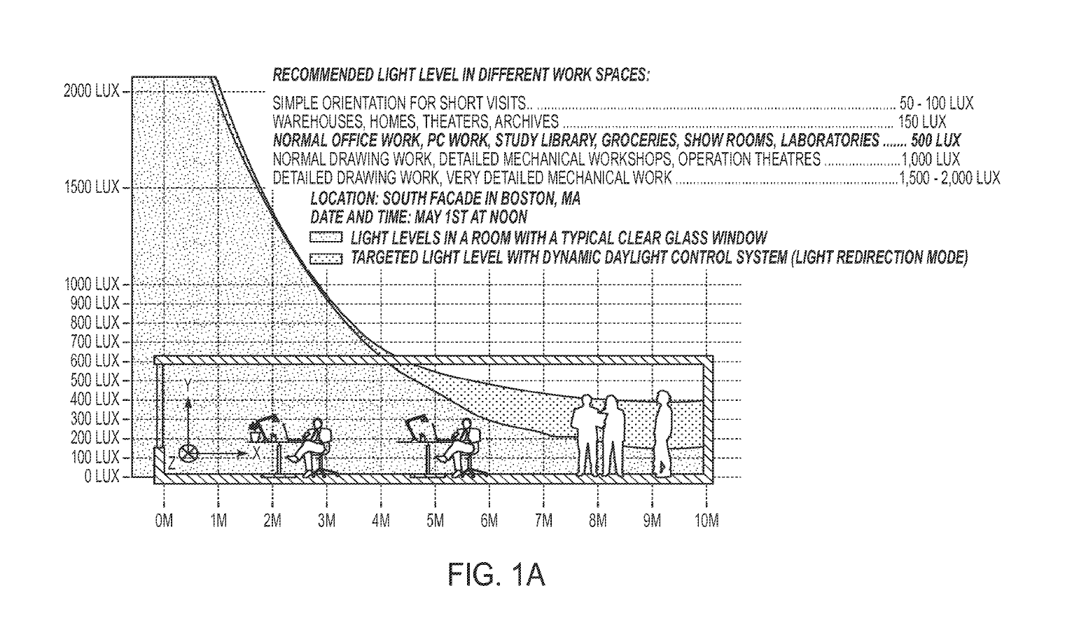

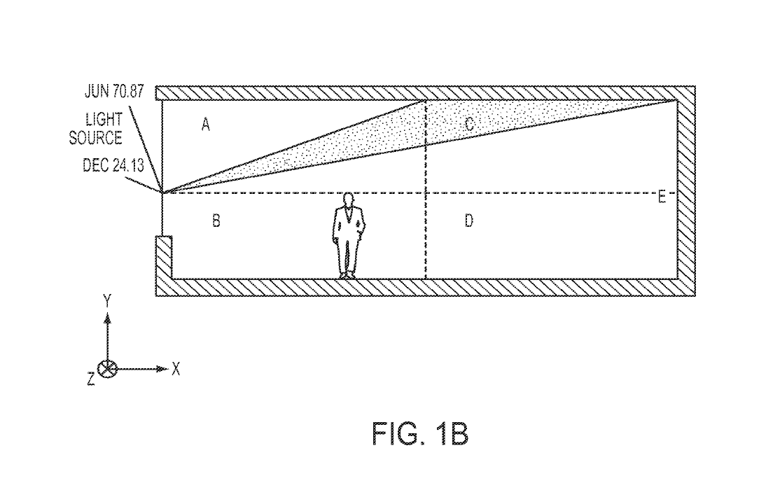

One of the key goals of daylight control systems is to improve daylight autonomy by increasing the time where interior zones of the building are at a target minimum luminance level by maximizing the daylight level at the rear of the space. FIG. 1A shows a typical daylight illumination that can be achieved using a clear glass (bottom curve) compared to the daylight illumination that can be achieved using the dynamic light control system of the present disclosure (top curve). The targeted luminance levels vary based on the space types, such as described in the IESNA Lighting Handbook. Other objectives of the dynamic light control system include lowering excessive lighting levels near the window, minimizing glare, generally modulating the direct daylight level for comfort and productivity, providing an unobstructed view through the window, inducing opacity for high incoming light levels, and the like.

In a particular embodiment, FIG. 1B shows a typical office space that is separated in four different regions. The vertical line delineates the façade zone near the window (regions labeled as A and B) and the secondary zone (regions labeled as C and D). For example, the secondary zone D may contain rows of work desks. Generally, the aim for light redirection is to direct sunlight to the regions C and D shown in FIG. 1B. As the sun's position constantly changes, a dynamic light control system that can adjust to redirect light to the desired region of the interior space and dependent on the space geometry and functional areas is needed. The conventional systems described above, such as light shelves, blinds, louvers, prismatic glazing systems, and laser cut panels are not able to provide the needed redirection as these are static systems.

The present application describes a Dynamic Light Control System (DLCS) having two or more confinement panes and one or more light redirecting elements that are arranged to deform (e.g., elastically) in response to one or more stimuli to account for a change in the direction of light. The dynamic light control system can further include a fluid flow cell (e.g., milli-fluidic channel systems filled with liquid or gas) that can further dynamically adapt to different sun positions, interior lighting levels or serve an aesthetic, visual function.

In certain embodiments, the dynamic light control system can be integrated or retrofitted to the interior or the exterior of any regular glazing system. In certain embodiments, the dynamic light control system can be attached to any regular glazing system that allows adjusting the redirection angle, the degree of diffuse and direct transmission and visual transparency of the façade.

In certain embodiments, the dynamic light control system can control the degree of diffuse and/or direct transmission of light. For example, the dynamic light control system can allow adjusting the light redirection angle by deformation of each light redirecting elements, such as light shelves and/or waveguides.

As another example, the dynamic light control system can deform one or more confinement panes to allow redirection and/or diffusion of the light passing through the system. As yet another example, the dynamic light control system can allow the control of fluid flow, where the light control system can be switched to visually transparent glazing by filling the fluidic channels with an index matched fluid. Alternatively, the fluid can contain light scatterers or absorbers to further reduce the transparency of the light control system or provide visual effects.

In certain embodiments, the fluid can be a liquid, such as water, alcohol, oil, other organic liquid, ionic liquid, liquid metal, phase changing materials, molten solid, or a solution containing refractive index modifiers, viscosity modifiers, salt, pigment, dye, particles, or a heterogeneous mixture or a suspension of immiscible liquids and/or solids, and the like.

In certain embodiments, the fluid can be a gas, such as air, nitrogen, argon, and the like. In certain embodiments, the gas can be a pressurized gas to deform the plurality of light redirecting elements and/or the confinement panes.

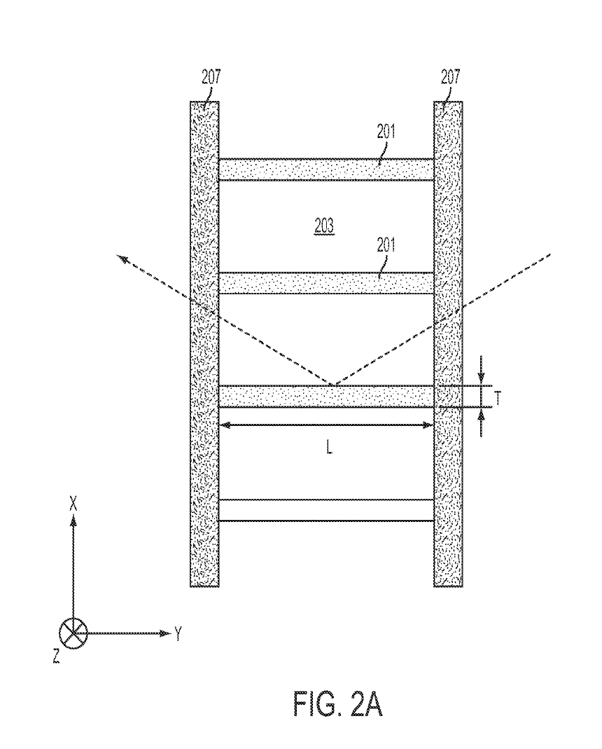

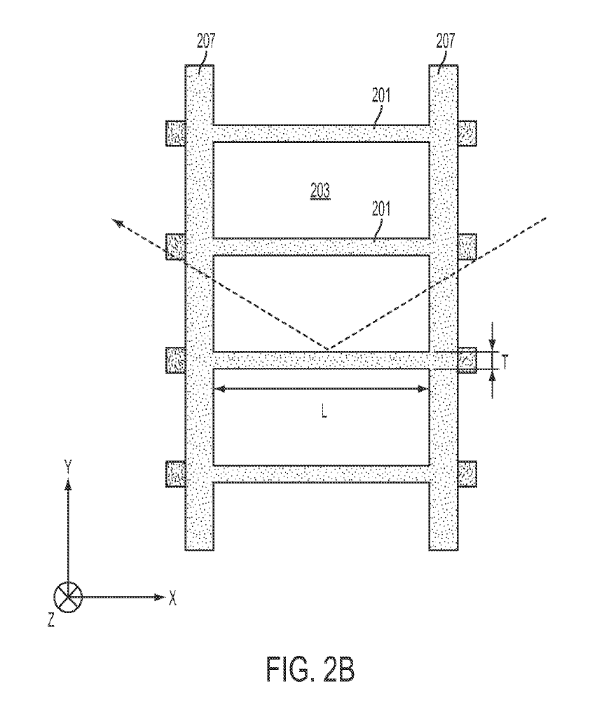

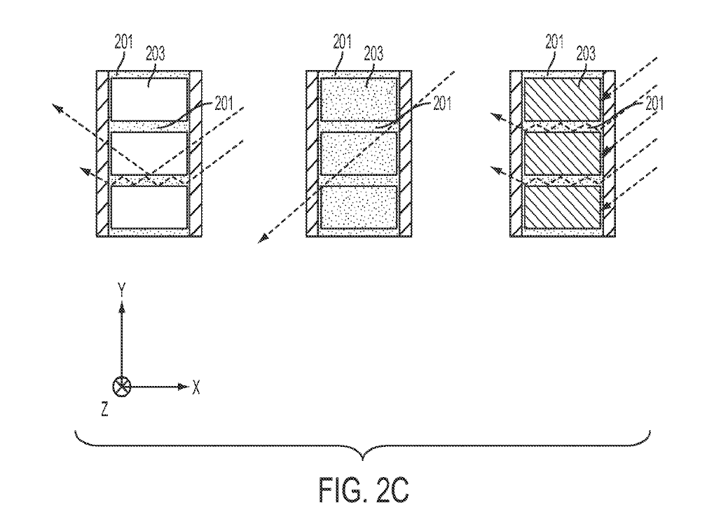

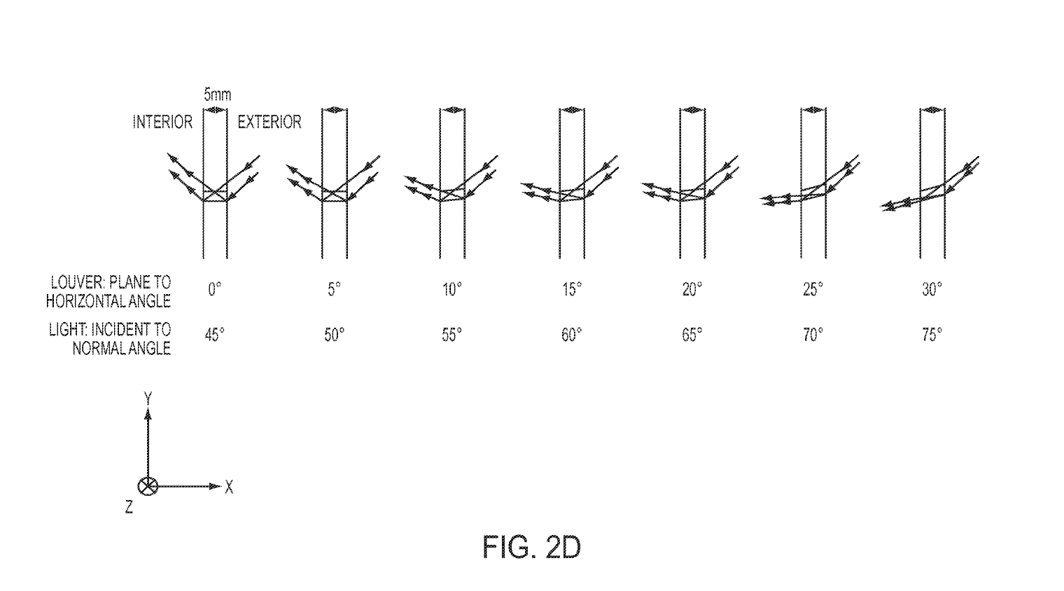

FIGS. 2A and 2B show a cross sectional view of the dynamic light control system situated between two confinement panes 205 and 207 having one or more fluidic channels 203 defined by one or more light redirecting elements 201 and the confinement panes 205 and 207.

Accordingly, as evident from FIG. 2A, the dynamic light control system avoids the pitfalls of mechanically hinging blinds and louvers by relying on elastic deformations of millimeter-sized light redirecting elements 201, such as for example, polydimethylsiloxane (PDMS) louvers. Located between and adhered to two light transmitting surfaces that are either optically clear materials, such as glass or acrylic or polycarbonate (see FIG. 2A), or non-transparent materials having transparent openings, such as mesh structures or slits (see FIG. 2B), the light redirecting elements 201, such as PDMS louvers, can change shape or orientation through the simple relative displacement of one versus the other confinement panes 205 and 207. Light can be redirected to the interior ceiling by reflecting off the light redirecting elements 201. From the ceiling, secondary reflections can bounce light back towards the floor to create desired interior lighting levels. Light redirection takes place because the index of refraction of light redirecting elements 201 differs from that of the fluid within the fluidic channels 203 (e.g. air, gas, or liquid) that fills the voids between the light redirecting elements 201. These interstitial spaces, however, are part of a fluidic network which adds several functions not normally present in dynamic light control system. By deliberately adding and removing fluids with specific optical properties the system can be configured to transmit, redirect, or reduce light (see FIG. 2C).

In the redirecting state (left in FIG. 2C), the fluidic channels 203 can be empty and the light can be redirected to the interior ceiling. Moreover, due to the refractive index contrast between the light redirecting elements 201 and the air in the fluidic channels 203, the system can be translucent, where the light redirecting elements 201 (e.g., PDMS louvers) remain visible and partially blur the view to the outside through the DLCS. It should be noted that a small percentage of light enters the interior through total internal reflection within the light redirecting elements 201.

Then, as shown in middle of FIG. 2C, in situations where unobstructed views to the exterior is desired, a refractive index matching fluid can be pumped into the fluidic channels 203. The fluidic channels 203 allow the light redirecting elements 201 to visually disappear and create an optically clear view for the inhabitants.

Yet another configuration can be achieved by filling a translucent or an opaque fluid into the fluidic channels 203, as shown in the right of FIG. 2C. In this case, sunlight can be either completely or partially blocked or diffused to achieve desired lighting levels, or to meet privacy requirements of the interior space. The combination of the three states makes the dynamic light control system (DLCS) unique compared to conventional light control systems, which require multiple individual assemblies to achieve light redirection, unobstructed views, and shading.

Moreover, FIG. 2D shows some exemplary configurations showing how the deformation and the change in the orientation of the light redirecting elements 201 can alter the direction of propagation of light into the space through the dynamic light control system. As such, redirection of light can be achieved as desired.

In certain embodiments, the light redirecting elements 201 has an index of refraction (n) between about 1.2 to about 1.8.

In certain embodiments, the materials of the light redirecting elements 201, in its bulk state, is transparent. For example, materials such as glass, polydimethylsiloxane, polycarbonate, polyvinyl chloride, polyurethane, polystyrene, polyethylene terephthalate, epoxy, poly(methyl methacrylate), polyacrylonitrile, polysulphone, polymethylpentene, cyclic olefin copolymer, may be utilized. As noted herein, it should be mentioned that while the light redirecting elements 201 comprise deformable materials, such as flexible elastomeric materials, light redirecting elements 201 can further contain rigid materials, such as glass, polystyrene, polycarbonate, and the like.

The fluidic channels can have light redirecting elements 201 having a thickness (T) and a length (L). In certain embodiments, the thickness (T) of the light redirecting elements 201 is about a few micrometers to about a few millimeters. For example, the thickness can range from about 10 μm to about 2 mm.

In certain embodiments, the aspect ratios (L/T) of the light redirecting elements 201 can be from about 1 to 20, such as from about 1 to 10. For example, if 100 μm thick walls 201 were utilized, the length of the walls may range from about 100 μm to about 1 mm or even 2 mm.

In certain embodiments, when an elastomeric material is used for the light redirecting elements the stiffness of the light redirecting elements 201 can range from about Shore 10A to 90A and Shore 10D to 80D.

The light redirecting elements 201 can be formed by any suitable means, such as by casting, injection molding, extrusion, laser cutting, and the like. The light redirecting elements 201 may be formed directly onto confinement panes or subsequently applied thereon.

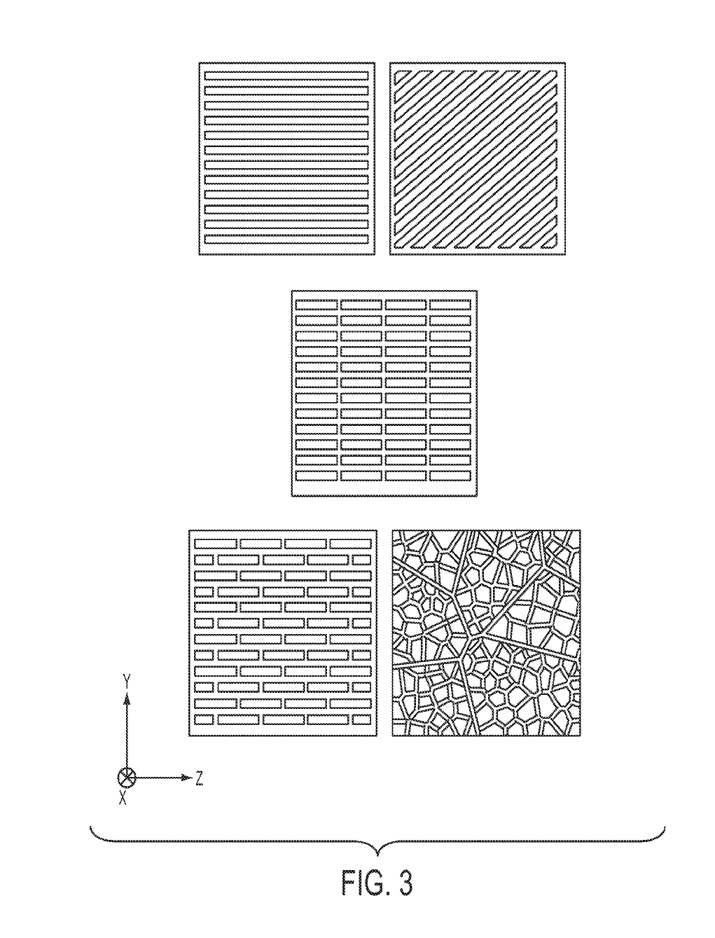

In certain embodiments, the shape of the light redirecting elements 201 can be a closely spaced array of rectangular bars attached to a glazing surface. For example, FIG. 3 shows five different exemplary dynamic light control systems viewed along the x direction of FIG. 2A (i.e., plan view). As shown, the length of each rectangular bar of light redirecting elements 201 can be same as the entire width of the window or can be shorter than the width of the window with fixed gaps, for example, to promote the filling of liquid inside the channel. In some embodiments, the light redirecting elements 201 can be arranged in various patterns (e.g., vertically aligned, staggered). In some embodiments, the light redirecting elements 201 can be in an arbitrary shape and arrangement to create a pattern such as Voronoi pattern, capillary network, fractal based branching patterns, and the like.

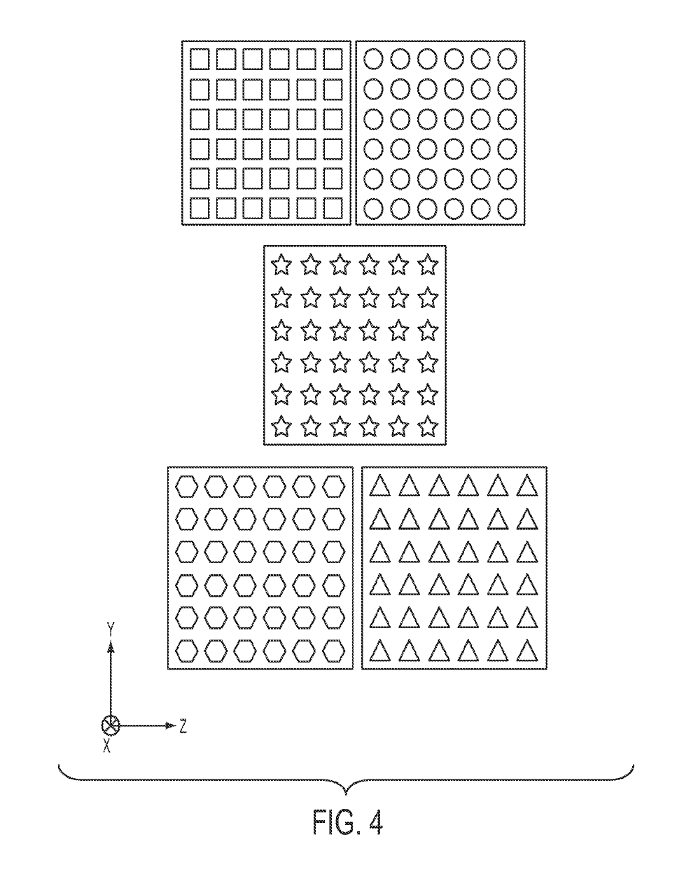

FIG. 4 shows five additional exemplary dynamic light control systems viewed along the x direction of FIG. 2A (i.e., cross-sectional view). As shown, the cross-sectional shape of the light redirecting elements 201 can be any arbitrary closed shape such as circles, ellipses, triangles, rectangles, polygons, stars, and the like. In such a configuration, the light redirecting elements 201 can function as light guides, similar to a waveguide structure. In certain embodiments, the arrangement of the light redirecting elements 201 can be arbitrarily arranged to create a desired pattern.

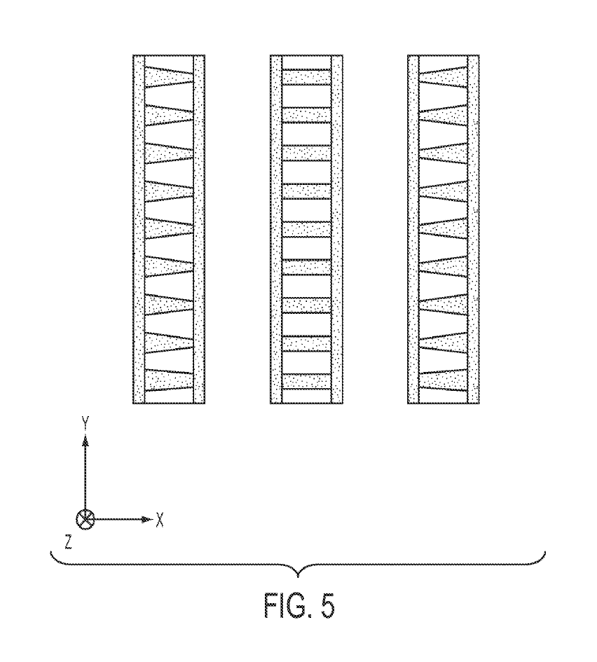

In certain embodiments, the light redirecting elements 201 can be arranged in any desired configuration to further redirect incoming light into various different locations. For example, FIG. 5 shows a cross-sectional view (i.e., viewed along the z-direction in FIG. 2) showing three exemplary configurations that can be adopted. On the left, the light redirecting elements 201 are tapered while they are inversely tapered on the right. The middle figure shows no tapering, but a consistent thickness along the x-direction. FIG. 6 shows four additional exemplary cross-sectional views where the light redirecting elements 201 are tilted, curved, bent, and S-shaped (from left to right). Other configurations, such as sinusoidal, zigzag, and the like can be envisioned.

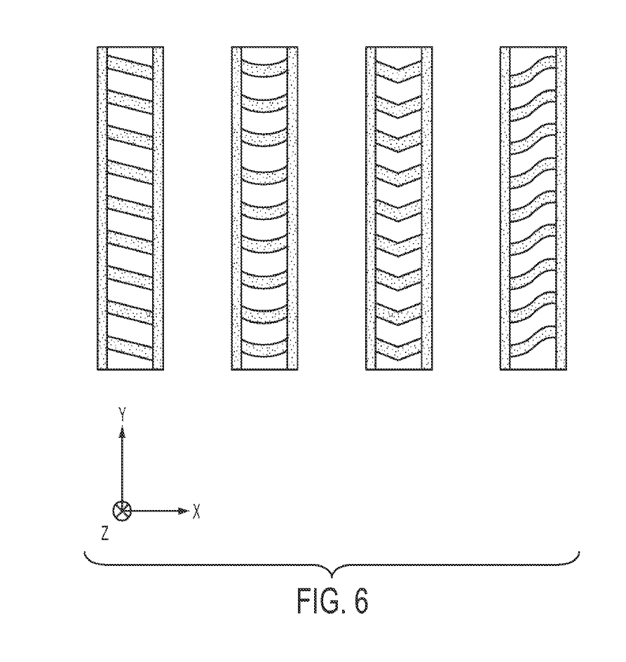

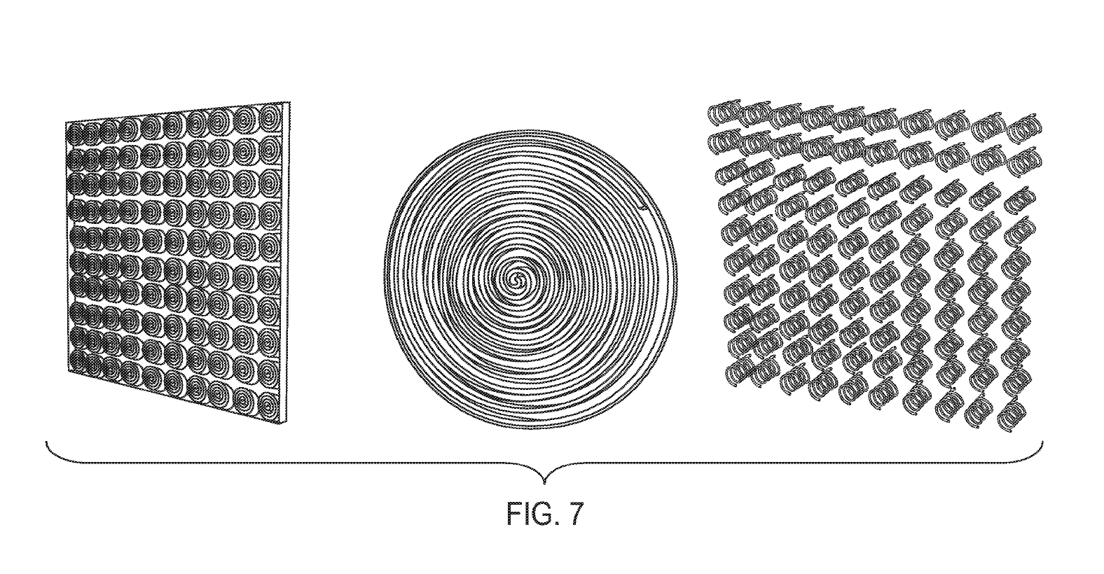

As illustrated herein, any different configurations of the light redirecting elements 201 can be envisioned. For example, as shown in FIG. 7, the light redirecting elements 201 can even be varied three-dimensionally, such as in the shape of a spiral or a helix.

In certain embodiments, the fluidic channels 203 can be filled with desired fluids or emptied as needed. The fluid can include any flowable medium, including solid particles, liquids and gases as well as combinations of any of the materials. In some other embodiments, the fluid can include colored dyes or other materials that change the light transmission properties of the fluid to modulate the light energy that is transferred into a room and further improve energy efficiency, as well as esthetic value. In some embodiments, different fluids can be selectively fed into the dynamic light control system to modulate light and heat transfer in response to changes in environmental conditions. For example, bright sunlight can be diffused using a more opaque or light diffusing or scattering fluid that has high heat absorbing properties to reduce the brightness and lower the temperature in the room. Examples of suitable fluids can include, water, oil, air, gas, suspensions of materials and particles (e.g. near-infrared reflecting particles) in water or air, and the like.

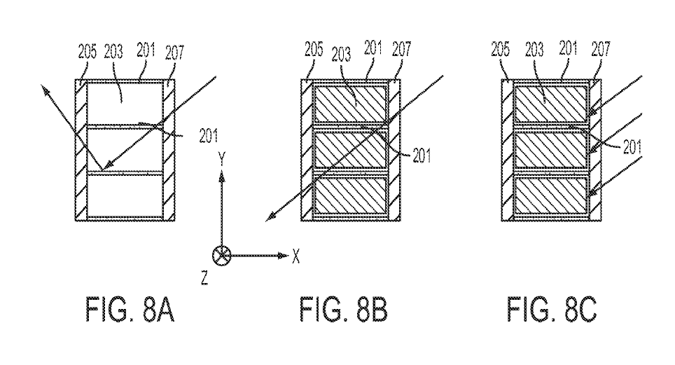

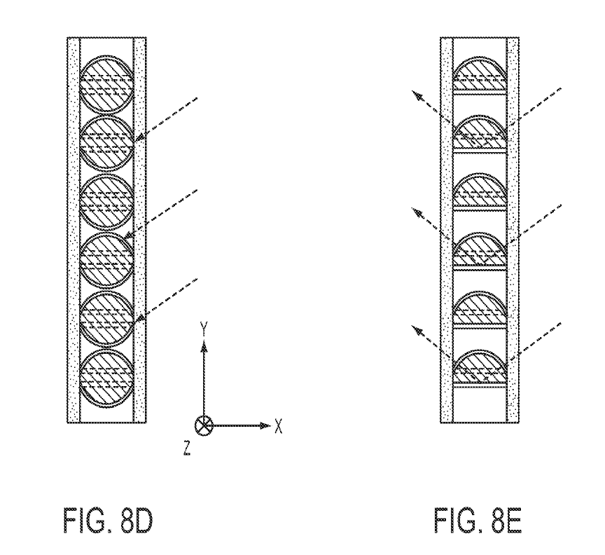

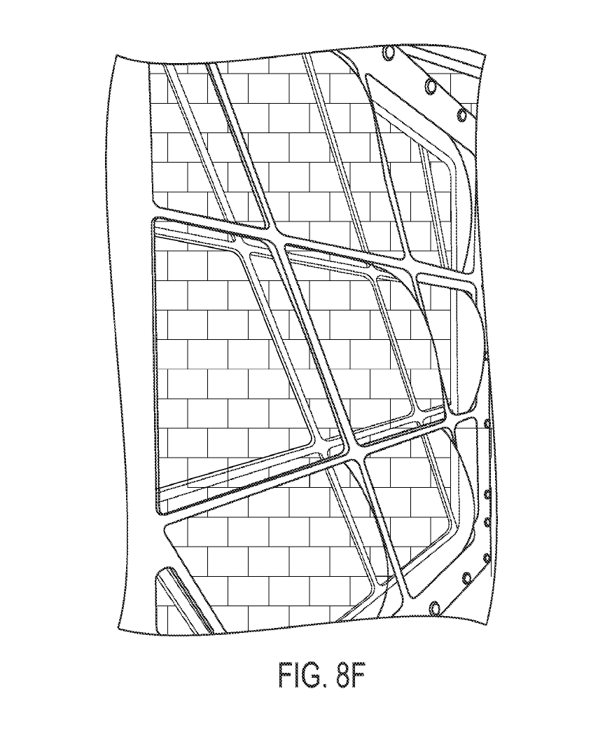

FIG. 8 shows some exemplary states of a dynamic light control system that are filled with desired fluids or emptied as needed.

As shown in FIG. 8A, the fluidic channels 203 are emptied to provide redirection of the light as the index of refraction difference between the fluidic channels 203 and light redirecting elements 201 maximized. As a result, light can bounce off the light redirecting elements and be diverted to desired directions as shown in the figure. In certain embodiments, the fluidic channels 203 can be filed with a fluid that has a largely different refractive index than that of light redirecting elements 201 (e.g., air, other types of gas, or other liquids having a high refractive index difference from that of the light redirecting elements). If desired for aesthetic reasons, the fluid can be colored or provided with other solutes that have certain desired aesthetic or other properties.

In contrast, as shown in FIG. 8B, the fluidic channels 203 are filled with a transparent fluid having an index of refraction that is approximately the same as that of the light redirecting elements 201. As a result, the dynamic light control system becomes substantially transparent and light can transmit through the confinement panes 205 and 207 as shown in the figure.

In certain embodiments, as shown in FIG. 8C, the fluidic channels 203 can be filled with a liquid that is not-transparent. As a result, light is not transmitted through the dynamic light control system as shown in the figure. For example, the liquid can contain absorbers, precipitates that cause scattering of light, diffusers, coloring agents, and the like. In some embodiments, the fluid can block undesirable wavelengths of the electromagnetic spectrum, including all or portions of the ultraviolet, visible, near-infrared and infrared spectrum. For a dimming effect, the fluidic channels 203 can also be filled with highly absorptive liquids. These properties could dynamically adjust to the lighting conditions.

In certain embodiments, as shown in FIG. 8D, the two or more unconnected fluidic channels 203 can be designed, with only select channels filled with a pressurized fluid, such as gas or liquid, that causes deformation of the light redirecting elements 201. As a result, many different light redirection effects can be obtained, depending on the type of fluid that is flowed into the fluidic channels 203 and its pressure. For example, symmetrical deformation of planar deformable light redirection elements into curved structured as shown in FIG. 8D will result.

In certain embodiments, as shown in FIG. SE, some of the light redirecting elements 201 can be formed using a deformable material while some of the light redirecting elements 201 can be formed using a rigid, or less deformable material. As such, when one of the fluidic channels 203 is filled with a pressurized fluid, such as gas or liquid, only the deformable light redirecting elements can deform, causing a lens effect that allow redirection of the light.

In certain embodiments, the light redirecting elements 201 may be made of rigid material while the confinement panes 205 can be made of deformable materials. Alternatively, as shown in FIG. 8F, only a small number of light redirecting elements (e.g., none to a few) can be provided. In such instances when the confinement panes 205 are made of a deformable material, when the fluidic channel(s) 203 are filled with a fluid, such as gas or liquid, the confinement panels can deform to achieve light redirection or diffusion.

Many different types of confinement panes can be utilized. For instance, the confinement panes can be a glazing pane, a transparent pane, a translucent pane, a non-transparent pane having one or more transparent or translucent regions, a pane having one or more cutouts, and the like. The confinement panes can be rigid, soft, or contain soft regions and rigid regions.

In certain embodiments, the fluid can be fed and pushed through the fluidic channels 203 using gravity, capillary action or an active pressure source such as a pump or an elevated reservoir. The fluid can be fed in the top of the window or other glazing system and gravity can be used draw the fluid down through the dynamic light control system to one or more outlet ports at the bottom of the window. Alternatively, the fluid can be fed in the bottom of the window or other glazing system and the head pressure or capillary action can be used push the fluid up through the dynamic light control system to one or more outlet ports at the top of the window or other glazing system. In other embodiments, channels can be configured to enable the fluid to flow horizontally from one side to the other.

In certain embodiments, the dynamic light control system can include at least one inlet port and at least one outlet port to enable a fluid to flow into and out of the fluidic channels 203. For example, a small pump and tanks that can find space in the framing of the glass can be utilized to drive the fluids through the inlet and outlet ports. The liquid can be run through a closed loop system with one or more than one type of liquid flowing in series.

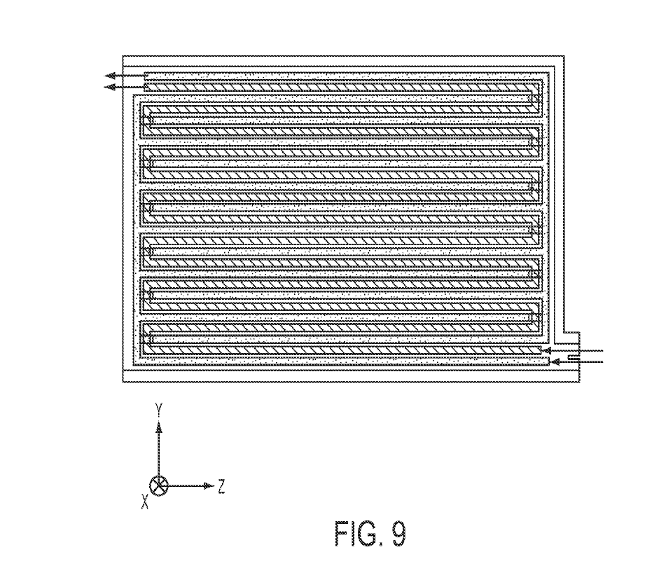

In certain embodiments, more than one fluid can be utilized to fill the fluidic channels 203 and dynamically adjust the light redirection. For example, through strategic adjustment of the fluid flow in multiple fluidic channels 203, many different light direction systems can be formulated. FIG. 9 shows an exemplary dynamic light control system having two different fluidic channels filled with two different fluids. As shown, two different inlet and outlet ports are provided to the two different fluidic channels 203 that can flow in or out any desired fluids.

In certain embodiments, only a portion of connected fluidic channels 203 can be filled with fluids and pressurized. As a result, the walls of the fluidic channels 203 can deform so that the curvature of each light redirecting element 201 can be controlled. For example, one of the fluidic channels 203 in FIG. 9 can be filled with air and pressurized to slightly expand and deform the channel walls, which in turn can change the direction of light reflected or guided by the light redirecting elements 201.

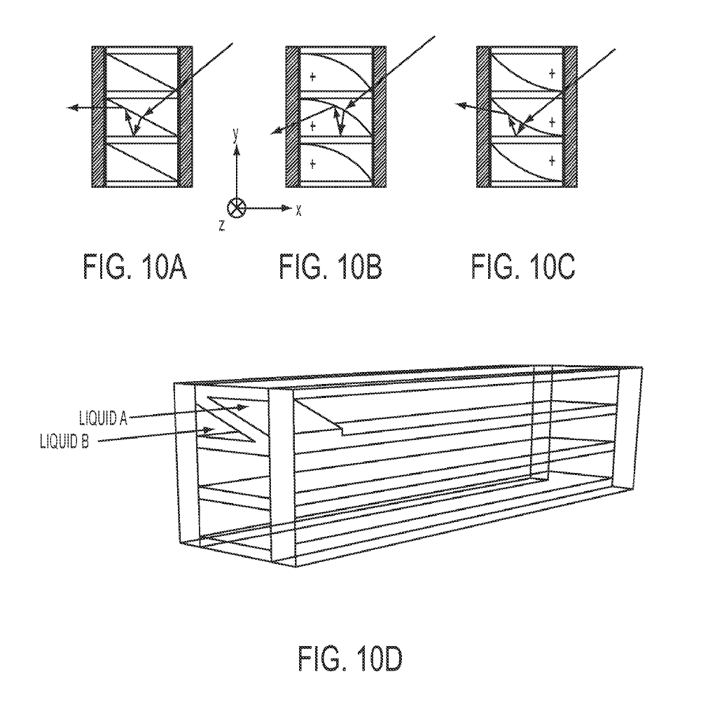

FIG. 10 shows another exemplary dynamic light control system where two different fluids are provided in the same fluidic channel 203. For example, as shown in FIG. 10A, fluids that are diagonally split into two different sections can be flowed through the fluidic channel 203. As shown in FIG. 10A, due to the index of refraction difference between the two fluids, different light redirection properties from that a single fluid can be achieved as light changes its propagation path at the interface between the two immiscible fluids.

Pressurizing the fluids differently can deform the geometry to further change the light redirection properties. For example, as shown in FIG. 10B, by providing a positive pressure to the bottom fluid (indicated by a “+” sign), the interface between the two immiscible fluids can change. As a result, as shown, the light redirection characteristics changes similar to that of a prismatic effect. In certain embodiments, the pressurization can be achieved by adjusting the flow rates of the fluids in each channel.

Alternatively, as shown in FIG. 10C, by applying a positive pressure to the top fluid (indicated by a “+” sign), the interface between the two immiscible fluids change in the opposite manner. As a result, as shown, the light redirection characteristics change yet again similar to that of a curved mirror effect.

FIG. 10D shows an exemplary channel inlet port that can be utilized to obtain the two fluid flow described above in relation to FIGS. 10A to 10C. For example, by providing two immiscible fluids (Liquid A and Liquid B) and flowing them into the fluidic channel 203 under laminar flow conditions, a flow similar to that shown in FIG. 10A can be obtained. In addition, by applying a positive pressure to the fluid flowing into the Liquid B inlet, a flow similar to that shown in FIG. 10B can be obtained. Alternatively, by applying a positive pressure to the fluid flowing into the Liquid A inlet, a flow similar to that shown in FIG. 10C can be obtained.

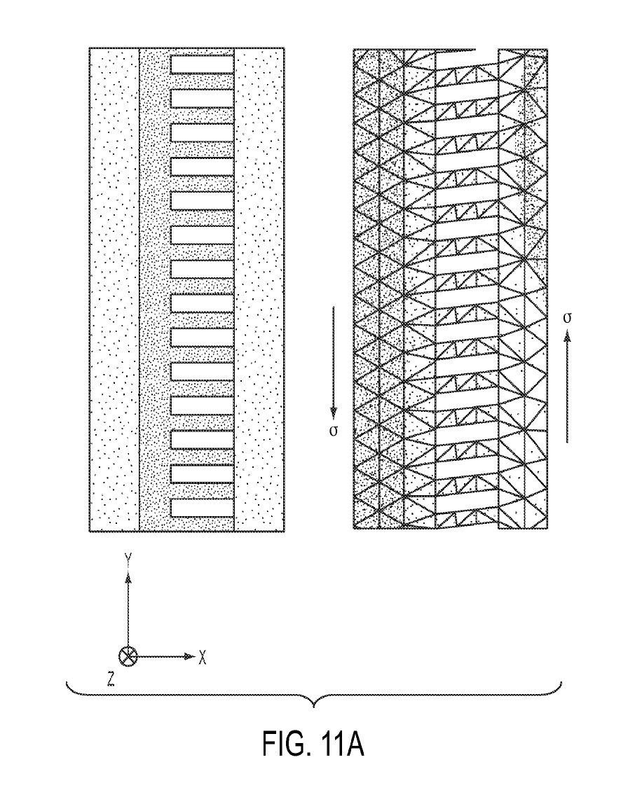

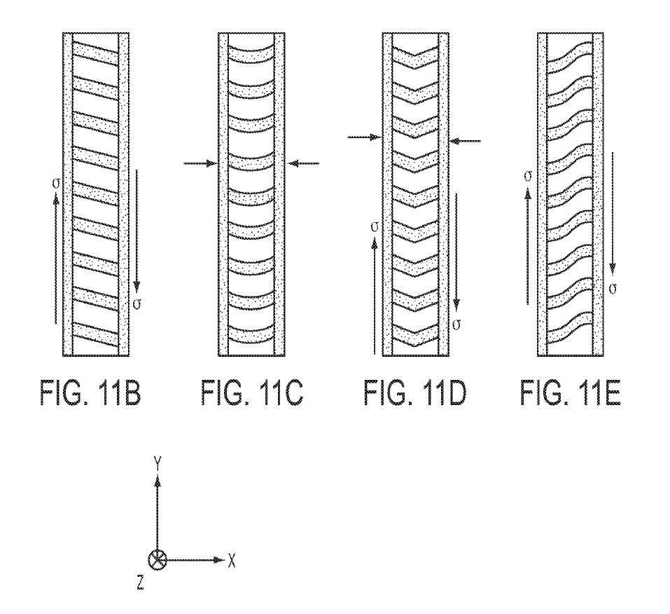

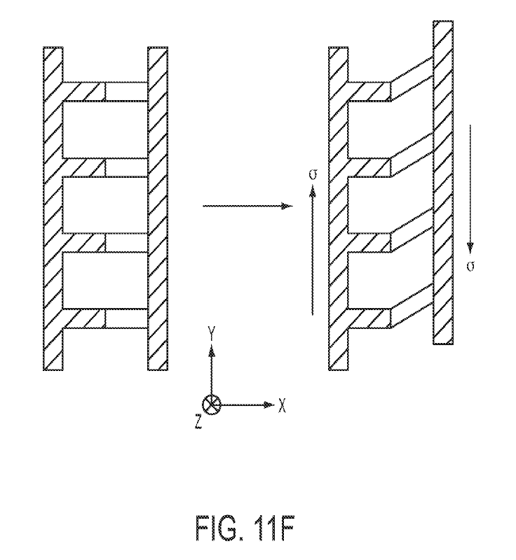

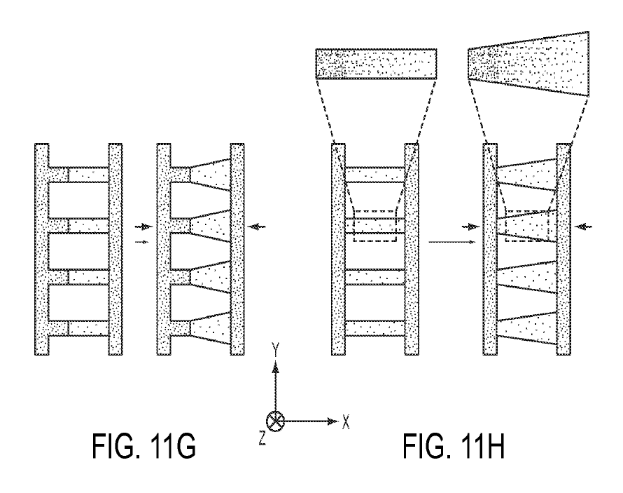

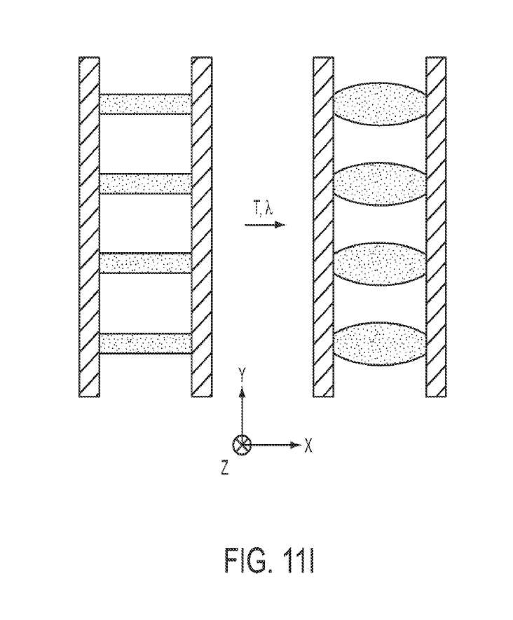

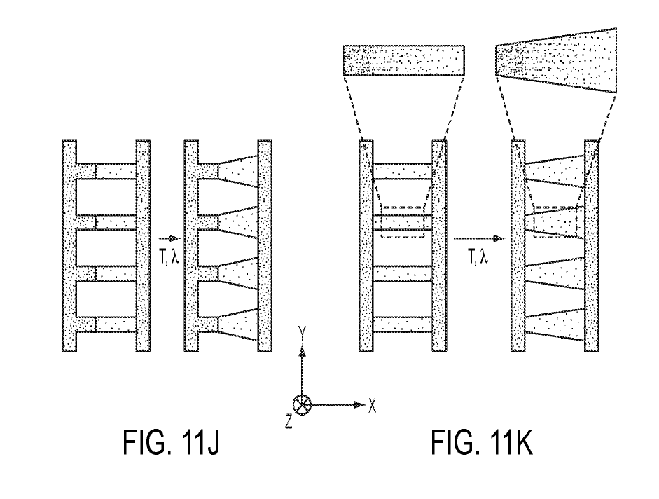

In certain embodiments, the dynamic light control system can be dynamically adjusted to compensate for the changing sunlight conditions by applying a desired deformation to the light redirecting elements 201. For example, as shown in FIG. 11A, applying a shearing stress (σ) to the confinement panes can provide desired deformation to change the tilt of the light redirecting elements 201.

The light redirecting elements 201 can take on any desired configuration upon the application of a deformation stress. For example, as shown in FIG. 11B, shear (σ) can be applied in the opposite direction to the confinement panes to tilt the light redirecting elements 201 in the other direction.

In certain embodiments, different shapes can form by choice of applying a different set of deformation stress to the dynamic light control system. For example, as shown in FIG. 11C, pressure can be applied to the confinement pane to form a curved surface.

In other embodiments, different structural designs can be introduced into the dynamic light control system. For example, a hinge (not shown) or a very soft material relative to the other parts of the light redirecting elements 201 (not shown) can be provided at the middle of the light redirecting elements 201. As a result, as shown in FIG. 11D, pressing the confinement pane can kink (or form sharp angles) at the middle of the light redirecting elements 201.

Another non-limiting example is shown in FIG. 11E. As shown, depending on the material (e.g., polydimethylsiloxane or other crosslinked rubber), shearing the confinement panes can lead to an S-shaped curvature.

In certain embodiments, as discussed herein, the light redirecting elements 201 can have a gradient of mechanical property along their length, such upon application of a force to move the light redirecting elements 201 can result in particularly desired geometries. For example, as shown in FIG. 11F, light redirecting elements 201 can have two types of materials that change in mechanical property along the x-direction. In such instances, when a shear force is applied to the confinement panes, the portion of the light redirecting elements 201 having a stiff material may not bend or tilt, while the portion of the light redirecting elements 201 having a soft material can bend, tilt, or curve.

FIGS. 11G and 11H show two additional exemplary embodiments, where the mechanical properties of the light redirecting elements 201 change along the x-direction. FIG. 11G shows an abrupt change in mechanical properties while FIG. 11H shows a gradual change in the mechanical properties. As shown, when the confinement panes are squeezed along the x-direction, the light redirecting elements can deform 201 in different manners to produce particularly desired geometries.

Many different configurations are possible by providing different materials and/or by providing different structural designs into the light redirecting elements 201.

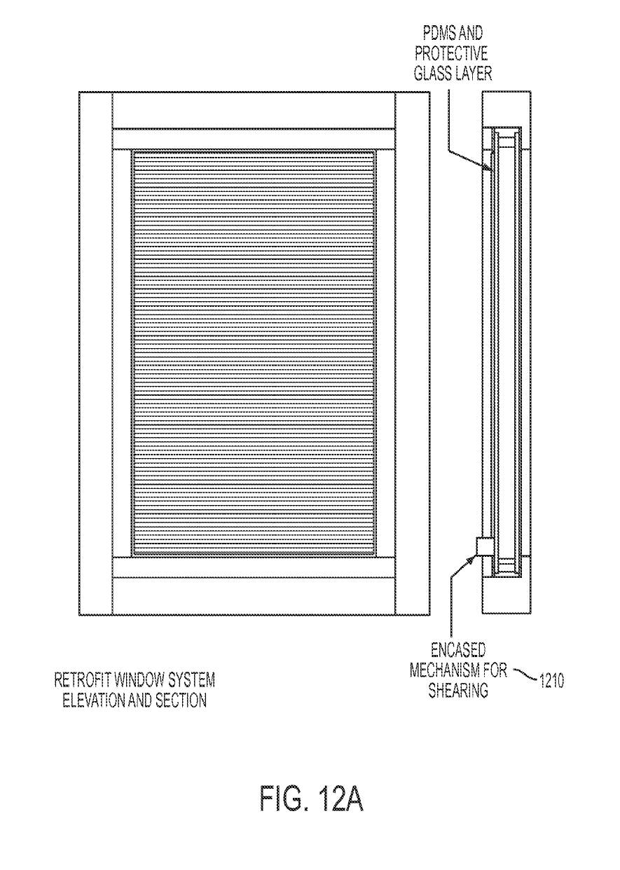

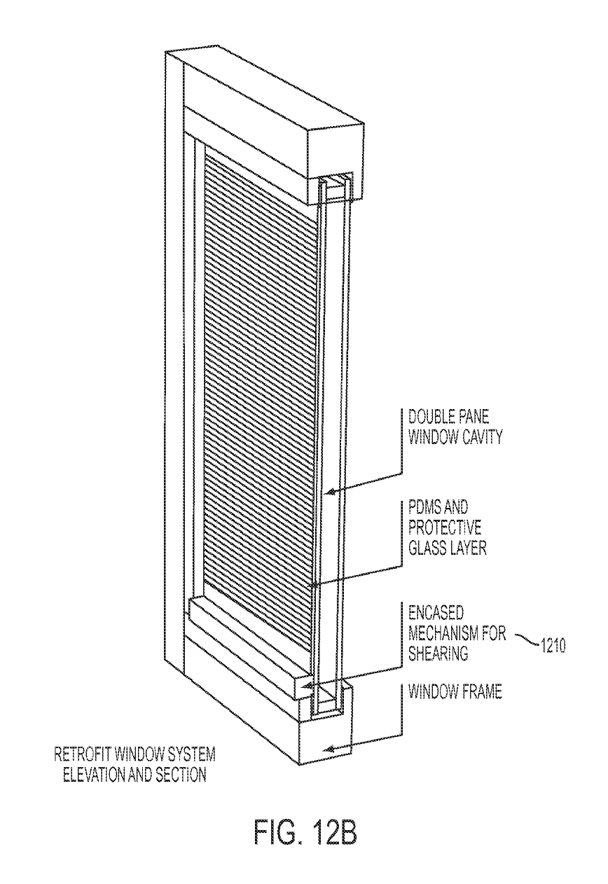

Many different methods to apply the desired deformation to the light redirecting elements 201 can be utilized. For example, as shown in FIGS. 12A and 12B, desired mechanism for shearing 1210 can be encased directly into the dynamic light control system. As shown in FIG. 12C, some non-limiting exemplary shearing mechanism 1210 include a crank, cam, stepper motor, phase change material, pneumatic systems, electromagnetic actuators, and the like. Generally, as shown, each of these different mechanisms can impart a shearing stress to the confinement panes by moving the confinement pane up and down to cause tilting of the light redirecting elements 201 as needed.

However, the desired deformation need not necessarily be applied in the form of a shearing stress or squeezing pressures. Other deformation stresses induced by elongation, compressions, temperature, pressure, and the like are within the scope of the various embodiments. For instance, by using responsive polymers to form elements 201, such as for example temperature-responsive or light-responsive hydrogel, the light redirecting elements 201 can deform in response to changes in light intensity or temperature, and the system will become self-regulated.

For example, if the light redirecting elements 201 are made of light or temperature-responsive gel with hard connection to two rigid panes, the light redirecting elements 201 will change into the shape of the lens as shown in FIG. 11I, upon swelling of the hydrogel in response to external stimulus. In particular, redirecting element 201 formed from a hydrogel that responds to the changes to light or temperature will self-regulate their shape and change from rectangular shape to cylindrical shape (as shown in FIG. 11I) upon expansion of the gel in response to the external stimulus. Upon contraction, the elements 201 will return to their rectangular shape.

As another example, as shown in FIG. 11J, if the light redirecting elements 201 are composed of two materials, one containing a light or temperature-responsive gel, then expansion of the gel will upon application of temperature (T) or light (λ) can change the shape of the light redirecting element 201.

As yet another example, if the light redirecting elements 201 are composed of a responsive material with a gradient mechanical property/volume change along the structure, then the system will self-regulate the geometry, similar to that shown in FIG. 11K.

In certain embodiments, the dynamic light control system can change its configuration from the one shown in the middle of FIG. 5 to one shown at the right or left of FIG. 5. Other self-regulated dynamic systems and geometries can be considered, in which the light redirecting elements 201 transform into any desired shape upon the change in the environment, such as temperature or light.

In certain embodiments, the dynamic light control system can further comprise optical sensors to determine the amount of sunlight incident upon the dynamic light control system to provide a feedback to the deformation mechanism and provide instructions on how to deform the light redirecting elements 201. For instance, an optical sensor may measure the amount of sunlight incident upon the light redirecting elements 201 and if the incident sunlight falls below a threshold amount, a feedback may be provided to the deformation mechanism to adjust the light redirecting elements 201 until the incident sunlight reaches or exceeds the threshold amount.

The dynamic daylight redirection system described herein provides numerous advantages over other conventional daylight control systems. For example, as shown in FIG. 13, since each conventional daylight control system is engineered to provide optimum performance for a limited number of aspects of daylighting, several systems are often required to be used simultaneously in order to achieve the desired overall condition. This approach can lead to the installation of redundant systems and is potentially costly. It can also reduce the daylight autonomy of the interior space due to multiple obstructing layers. For instance, as shown in FIG. 13, prisms and venetian blinds, as well as louvers and blinds, can simultaneously control shading, glare and light distribution, but the cost effectiveness, outside viewability, and daylight autonomy are sacrificed due to the multi-layered construction. Existing daylighting systems are often static, or only capable of limited adjustability, due to the cost and maintenance requirements for truly dynamic systems. Exterior mounted dynamic and retractable louver systems, for example, are effective in both controlling the lighting levels as well as minimizing thermal gain, but are difficult to maintain due to weathering and wind damage. Existing systems that reside in the cavity of a double glazed unit are better protected from the external factors, but they are also usually static, less efficient, and permanently obstruct views. Consequently, as summarized in FIG. 13, a minimalistic and simple solution that can combine various daylighting strategies (shading, redirecting, scattering/diffusing), dynamically adjust the redirection angle, and control diffusivity and visual transparency of the glazing is provided by the dynamic light control system (DLCS) of the present disclosure.

### Example

### Fabrication of PDMS-Based System

PDMS-based dynamic light control system (DLCS) was produced using four primary steps: (1) designing, (2) mold fabrication, (3) PDMS casting, and (4) attaching to glass sheets.

### Step 1: Design Stage

In the design stage, the geometry and pattern of the PDMS louvers are designed using Computer Aided Design (CAD) software. Depending on the complexity of the geometry, 2D and 3D drawings of the mold geometry are prepared. Several iterations of design are evaluated based on the size of the prototype, shape of base geometry, and density of the pattern. Finally, the base drawing of the mold geometry is chosen and prepared for the next stage.

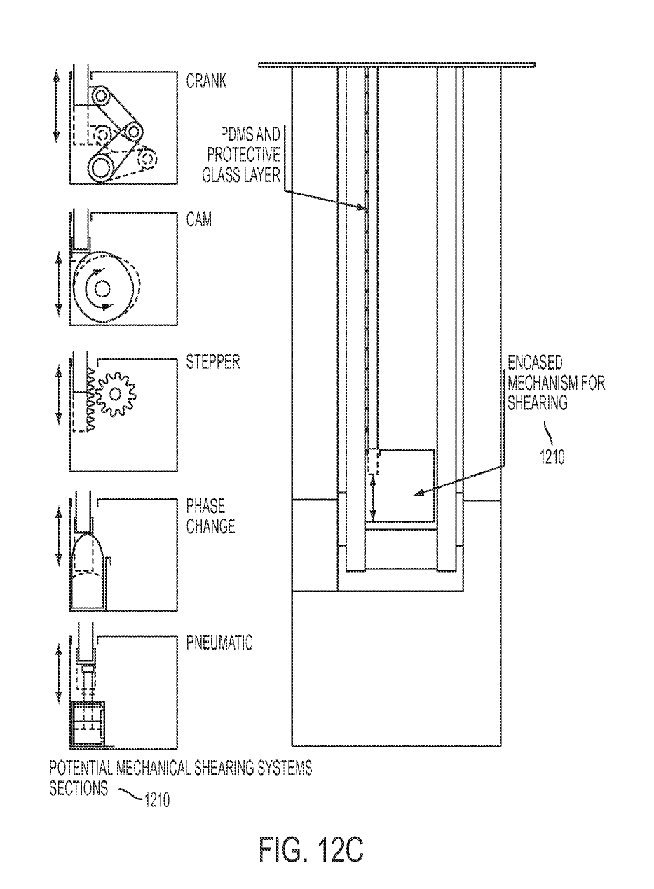

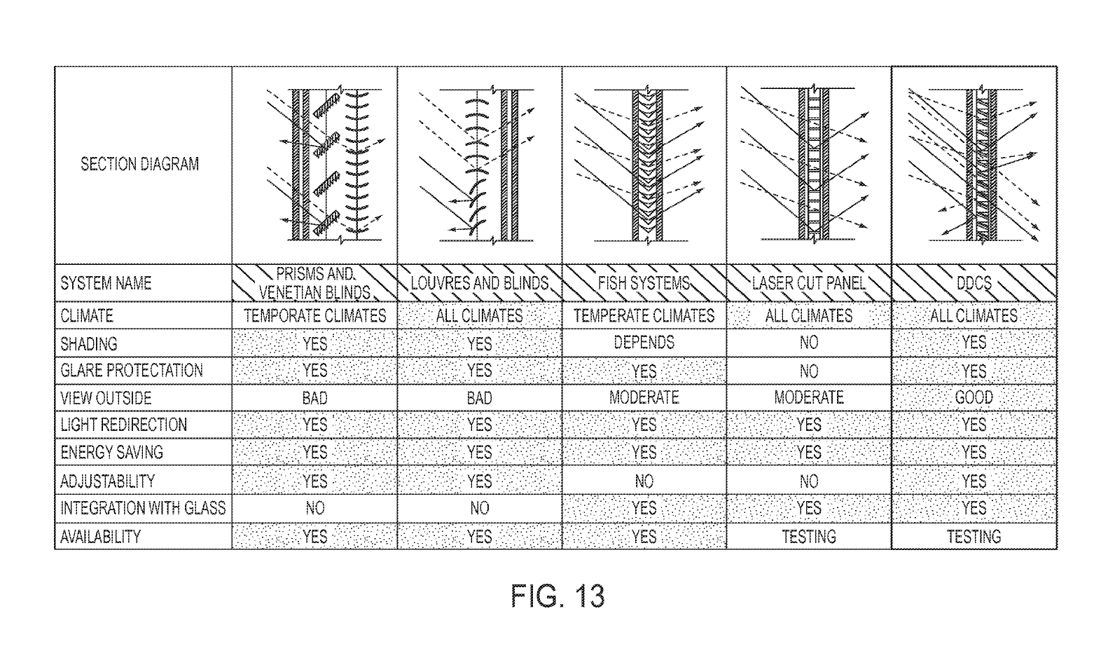

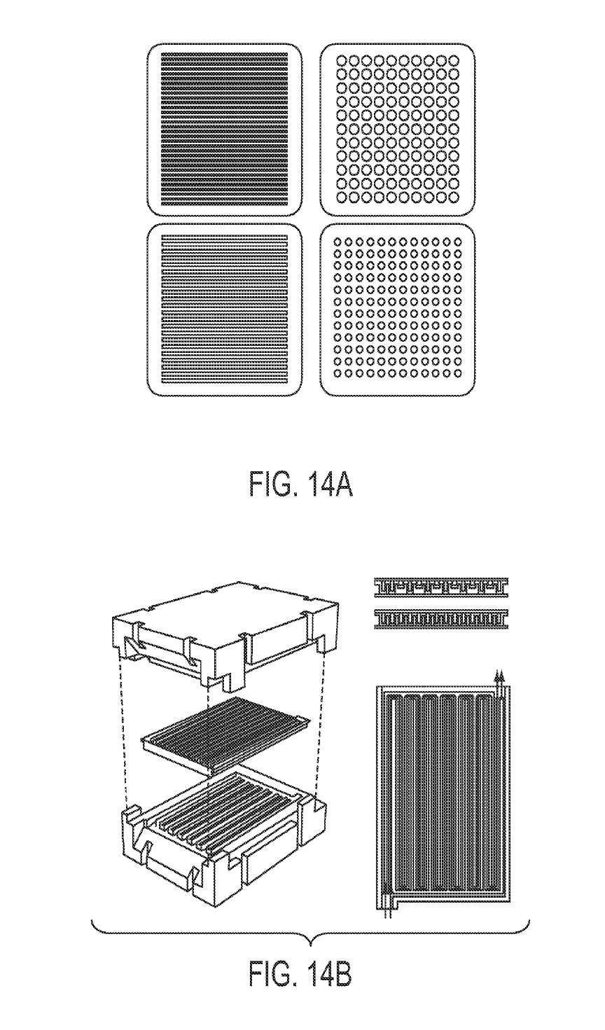

FIGS. 14A and 14B show two exemplary CAD drawings prepared for producing the DLCS in accordance with certain embodiments. For example, in FIG. 14A, light redirecting elements 201 that serve as light shelves (left column) and light guides (right column) were designed. The size of each square is about 4 inch by 4 inch.

### Step 2: Mold Fabrication Stage

In the mold fabrication stage, the mold was fabricated with a 3D printer (Objet Connex 500) using the CAD drawings prepared at the designing stage. Simple geometry designs (extrusion) utilized one part mold and more complex geometry designs (double sided channels) utilized two part molds. Once the mold was extracted from the 3D printer, the support material resulting from the printing process was cleaned using high pressure water jet and heated at 70° C. for 12 hours in order to remove any remaining volatile compounds.

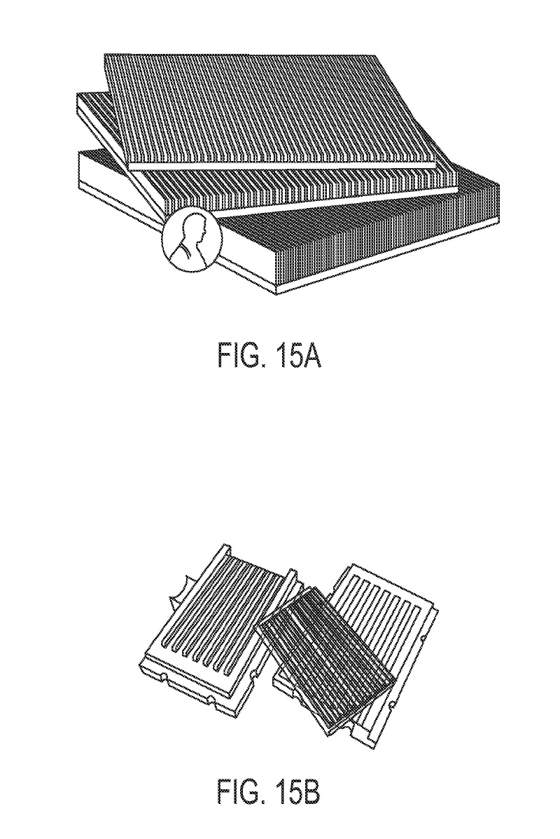

Exemplary master patterns for light redirecting elements 201, prepared as described above, are shown in FIGS. 15A and 15B. FIG. 15A shows to the 3D master molds printed using the CAD drawings shown in FIG. 14A and FIG. 15B shows the master molds (i.e., opaque materials on bottom) printed using the CAD drawings shown in FIG. 14B.

### Step 3: Mold Fabrication Stage

During the casting stage, the PDMS (Dow Corning Sylgard 184) material is mixed (two parts, 10:1) and poured into the prepared mold, degassed under vacuum for 2-4 hours and then thermally cured at 70° C. for 4-6 hours. After the curing process is complete, the cast is removed from the mold and cleaned for the next stage.

FIGS. 16A and 16B shows PDMS was cast in the master patterns to create negative patterns. FIG. 16A shows PDMS patterns replicated from the 3D printed master patterns shown in FIG. 15A. FIG. 16B shows PDMS patterns replicated from the 3D printed master patterns shown in FIG. 15B.

### Step 4: Attachment to Glass Sheets

Finally, the attaching stage involved spin coating a thin layer of PDMS on two sheets of glass, attaching the light redirecting elements made of PDMS shown in FIGS. 16A and 16B and repeating the curing process in the oven. The resulting DLCS prototype forms a fully integrated unit for testing the actuation.

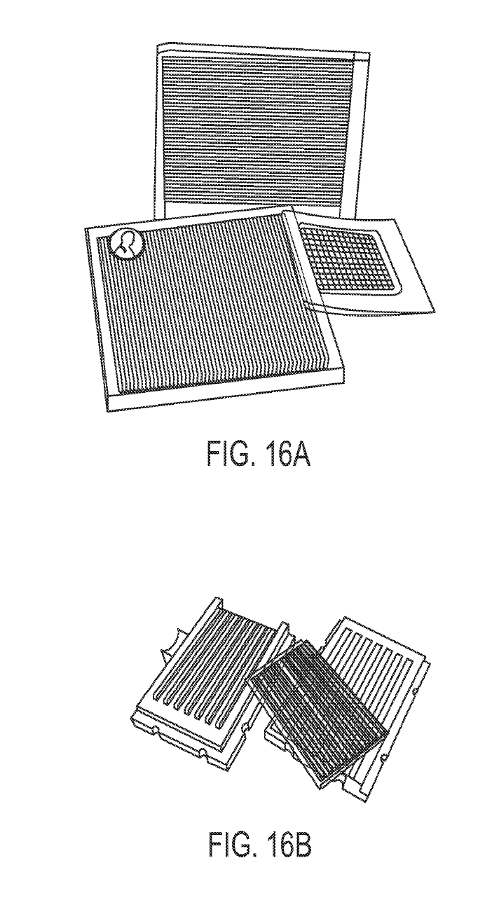

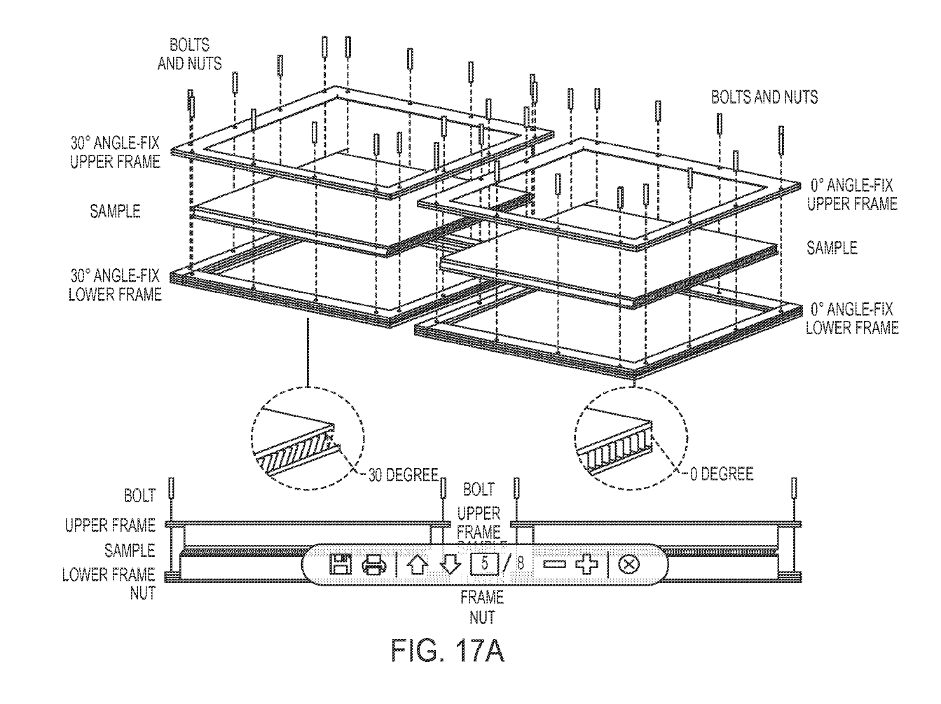

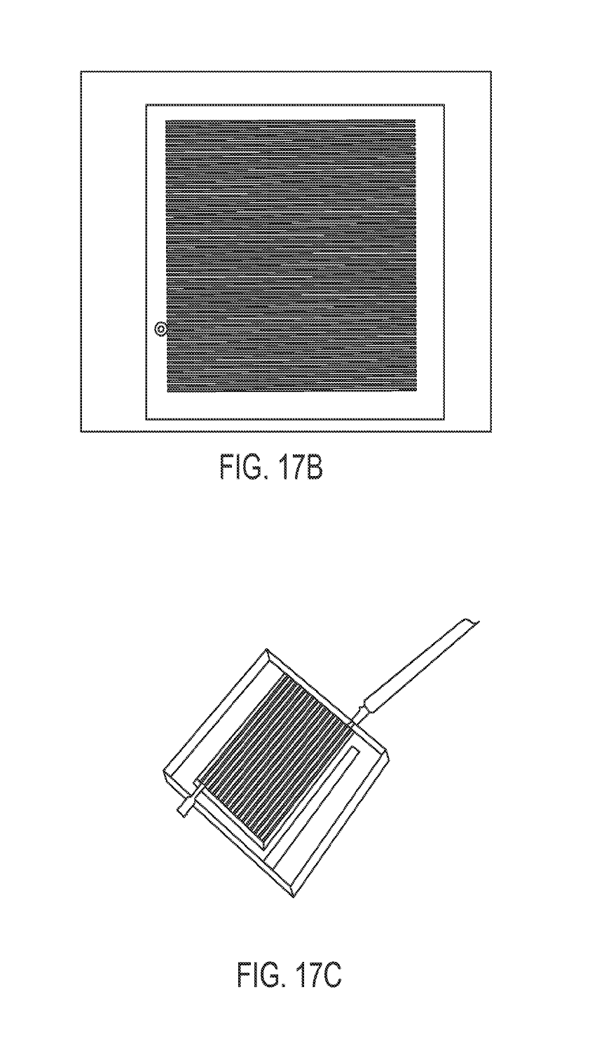

More specifically, FIG. 17A shows a schematic illustration of how the DLCS system is formed. As shown, the light redirecting elements can be attached to the glass sheets with or without an initial shear stress.

FIG. 17B shows a PDMS dynamic light control system retrofitted on the inner surface of a window using the PDMS light redirecting elements shown in FIG. 16A. FIG. 17C shows a PDMS dynamic light control system retrofitted on the inner surface of a window using the PDMS light redirecting elements shown in FIG. 16B.

### Preliminary Testing

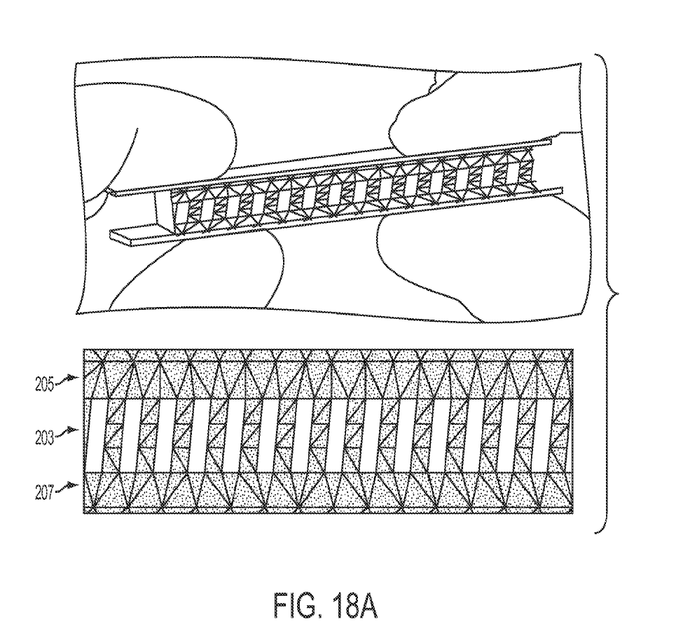

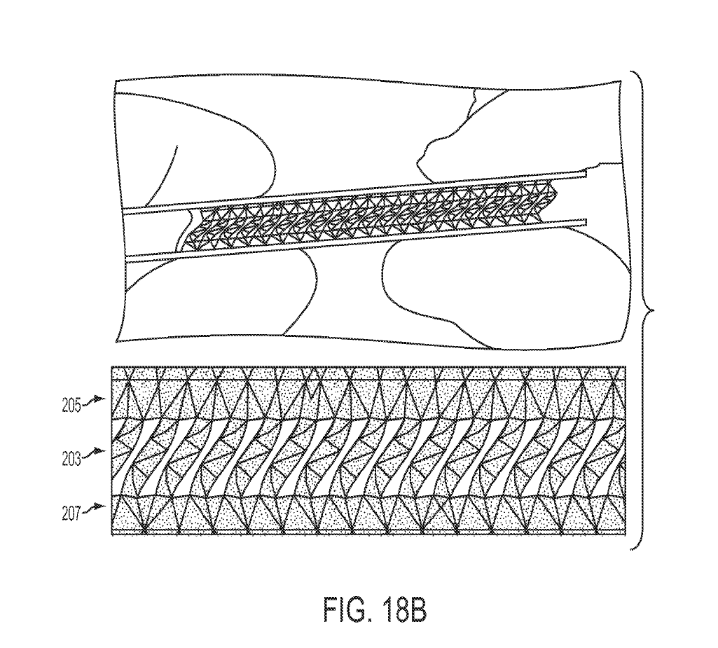

A series of physical tests were conducted to evaluate the properties of the DLCS. First, in order to analyze the deformation of the system during shearing actuation, both physical testing and computer simulations were conducted. FIG. 18A shows the physical sample and computer simulation studies in the undeformed state and FIG. 18B shows the physical sample and computer simulation studies in the deformed (e.g., sheared) state. Both the physical sample and computer simulation studies show an S-curve deformation perpendicular to the displacement direction of the glass panes, in which the buckled elastomeric louvers provide stress-relief for the system. As seen in the finite element analysis (FEA) studies show in FIGS. 18A and 18B, the maximum stress is at the interface between the elastomeric light redirecting elements 201 and the rigid glass panes 205 and 207.

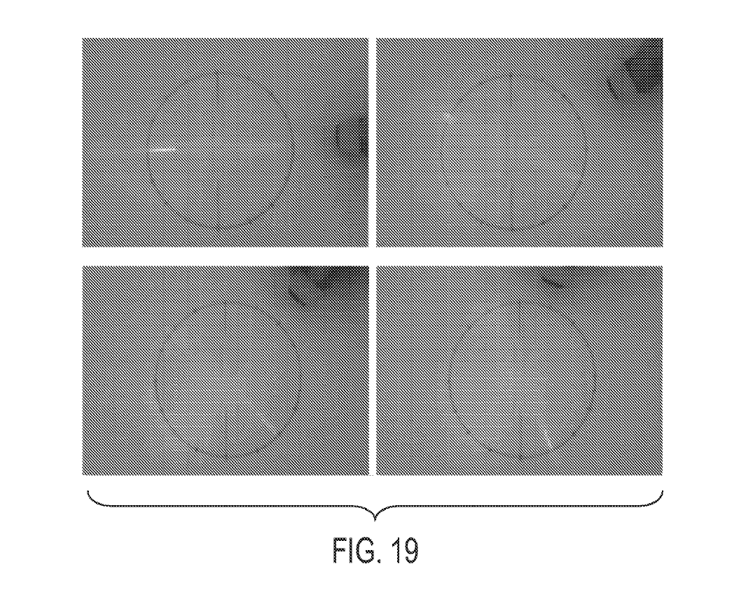

Next, the basic behavior of light redirection was tested by visualizing reflections through laser projections at multiple locations and angles. The light redirection effect is clearly visible in FIG. 19 even without shearing, showing reflection, refraction, scattering, and guide effect. Furthermore, by shearing DLCS these effects can be finely controlled with a fixed light position. The test, while qualitative, showed the potential of PDMS/air DLCS to effectively direct light into a desired space when used in the context of building façades.

### Quantitative Dynamic Light Redirection Tests

Following the initial proof-of-concept testing, several test setups were created to more specifically evaluate and ultimately measure the effect of light redirection. The tests include white box testing, black tube testing; and shoebox testing with intensity measurements using a light meter.

### White Box Test

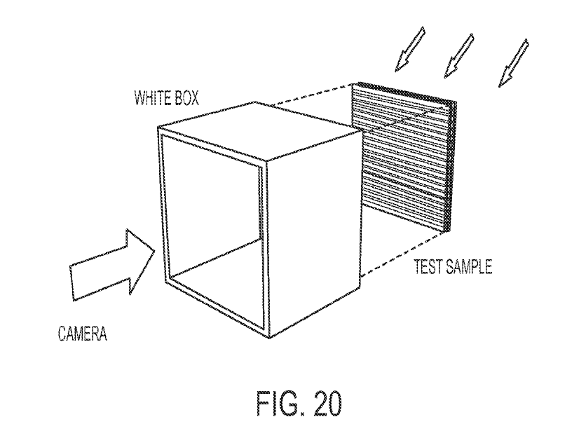

The white box test was performed using a box (two sides open and the inner surfaces are colored white) with a DLCS sample mounted on one open side as shown in FIG. 20. The illumination source (a 150 W fiber optic halogen lamp) was held outside of the box and the video was taken from the opposite open side of the box.

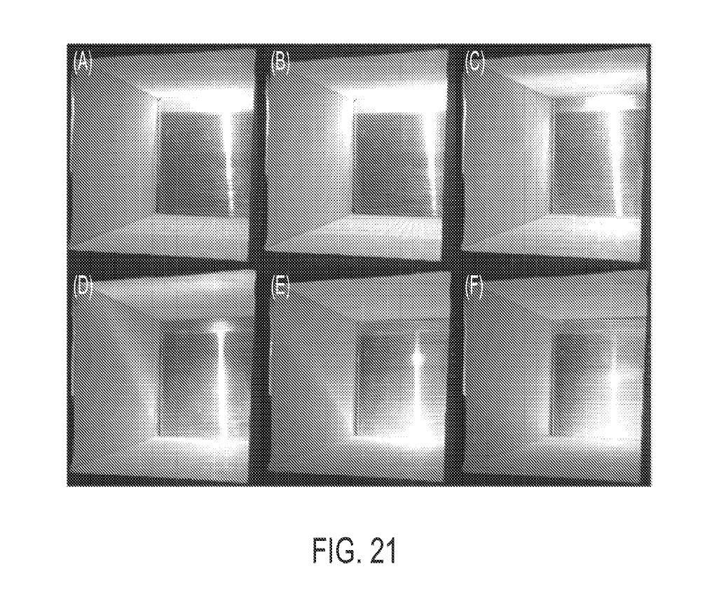

As the angle of the light source is changed, it was clearly visible that a portion of the light source reflects from the PDMS light shelves and projected to the top surface (ceiling) of the box. FIGS. 21A to 21D shows snapshots taken from the movie where this is observed.

This effect reverses when the angle of illumination source becomes lower, creating a glare effect (see FIG. 21E) on the bottom surface (floor). Furthermore, when the illumination source is perpendicular to the PDMS sample, the reflection of the light evens out, creating an overall illuminated lighting condition (see FIG. 21F).

### Black Box Test

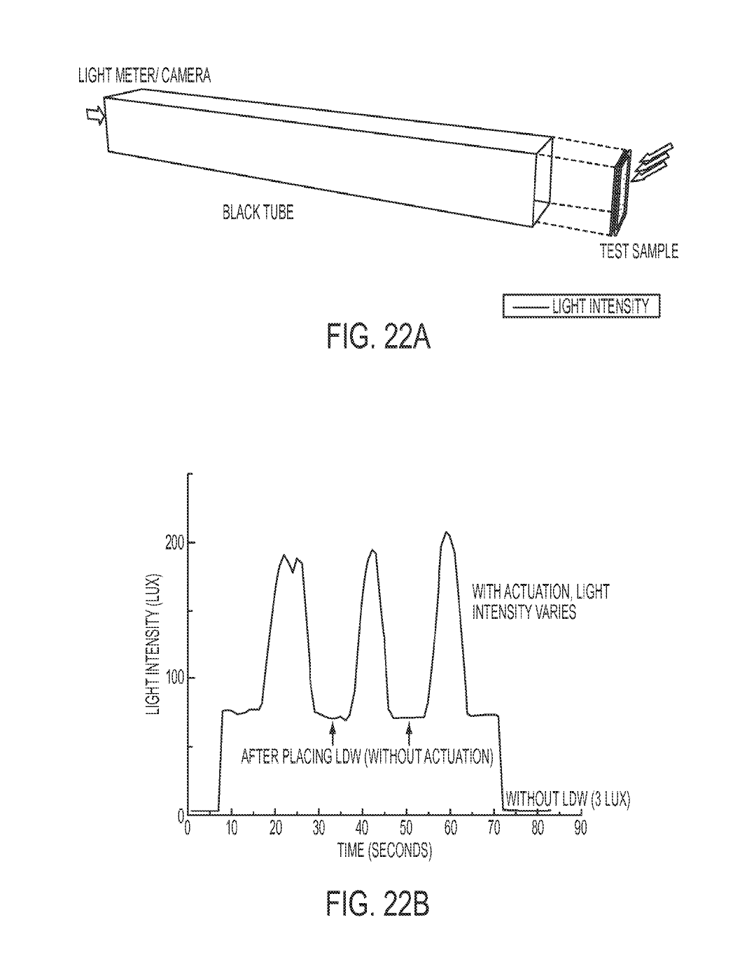

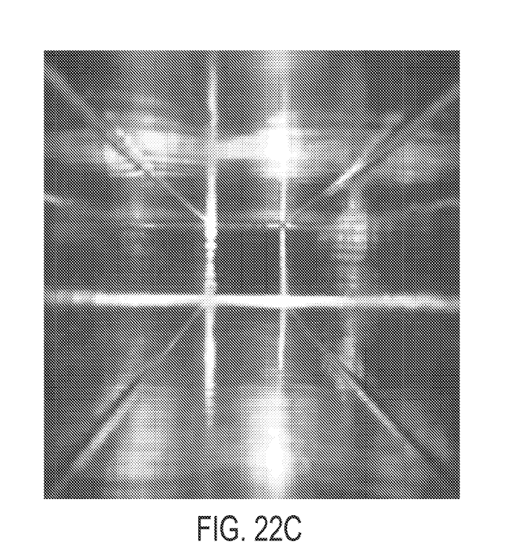

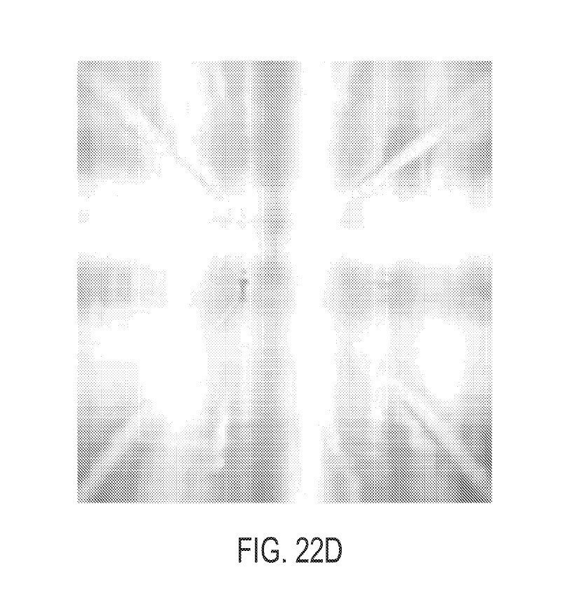

The black box test was carried out as follows. As schematically shown in FIG. 22A, the black tube testing consisted of a 1 m long square section tube with a light source and a DLCS sample at one end and with a light meter or a video recording setup at the other open end. The location of the light meter in this setup represents a spot deep inside a building far from a window, corresponding to location E in FIG. 1B.

A plot of the measured light intensities during a few shearing actuation cycles of the DLCS sample is shown in FIG. 22B. The maximum light intensities are observed at specific points of time when the angle of the louver redirects a large portion of the incoming light to the furthest length towards the light meter. As shown, without the dynamic light control system, only 3 lux was initially measured at the opposite side of the box far from the light source. After mounting the dynamic light control system (at around 10 seconds on the time axis), significant increase in intensity was observed (approximately 75 lux). After the light redirecting elements 201 were tilted by shearing (at around 20 seconds on the time axis), even greater illumination was achieve (approximately 180 lux). This effect was switchable based on shear tilting back and forth of the light redirecting elements, as demonstrated two additional times (between about 30 to 70 seconds on the time axis). As before, removing the dynamic light control system (around 70 seconds on the time axis), only 3 lux illumination was again observed.

FIGS. 22C and 22D visually show the lighting conditions through the actuation process. As shown in FIG. 22C, initially, the light was directed into areas corresponding to regions A and B of FIG. 1B. After tilting the light redirecting elements, FIG. 22D shows that light is directed deep into areas corresponding to regions C and D of FIG. 1B.

### Shoebox Testing

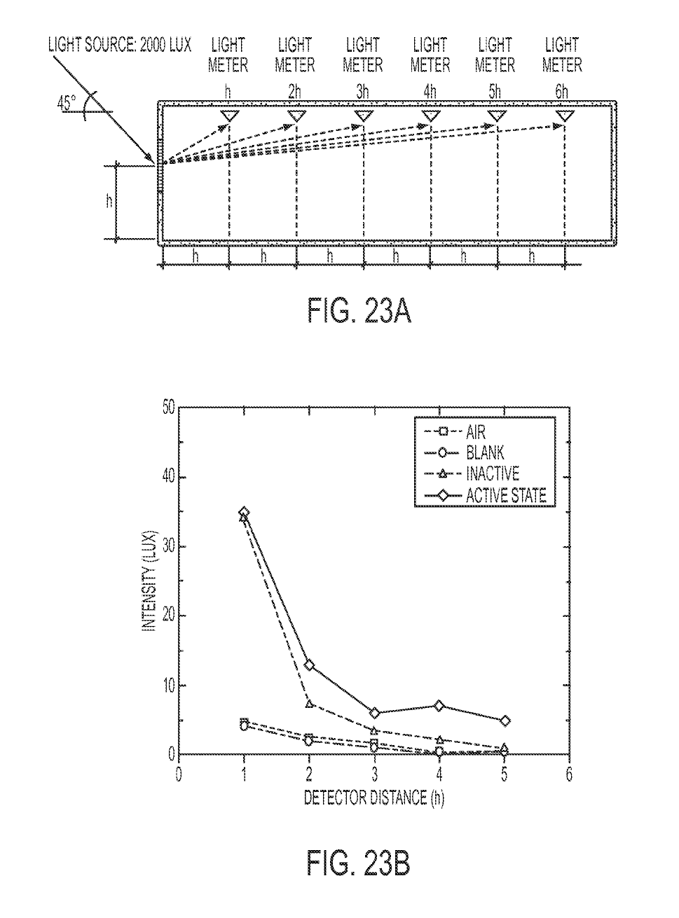

The next testing iteration examined the ability of the DLCS to direct light to various depths inside a simulated dark, non-reflective environment. As shown in FIG. 23A, a wood box (shoebox) with light-absorbing matte black finish on the interior was constructed, and the intensity of the redirected light was measured using a light meter along the top surface (ceiling).

FIG. 23B shows a plot of measured light intensity for four different window options as a function of parallel distance from the light-facing wall to the location of the light meter inside the shoebox. The measured data shows that when the DLCS is actuated, there is an approximately 700 percent increase in daylighting over the double glass sheets without the DLCS.

### Switching to a Transparent Window

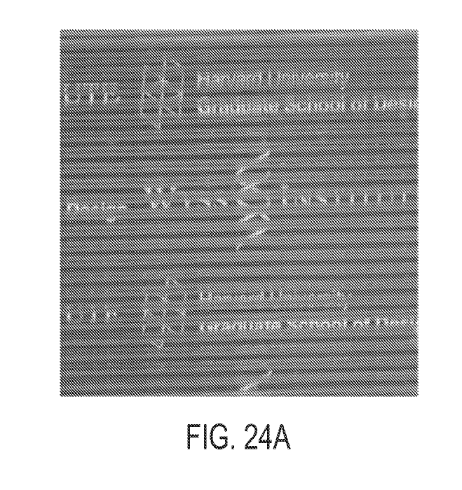

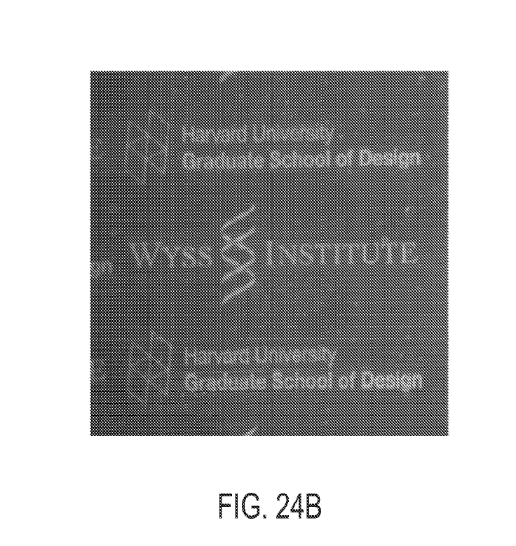

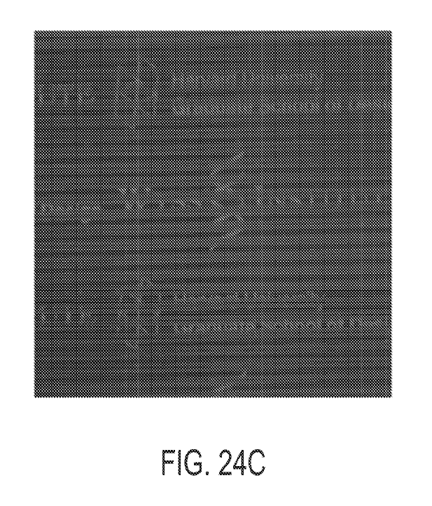

The fluid infiltration testing was conducted next. The sample was tested in three different conditions: default condition (no liquid), refractive index matching liquid-filled condition, and pigmented liquid-filled condition. As shown in FIG. 24A, in the default condition, the light redirecting elements are visible.

In the index matching liquid filled condition shown in FIG. 24B, the channels of the sample are filled with a mixture of glycerol and water that matches the refractive index of PDMS (1.43). Compared to the default condition, the light redirecting elements are nearly invisible.

In certain embodiments, only certain areas of the DLCS can be filled with index matching fluid. For example, as shown in FIG. 24C, a mixture of glycerol and water was filled in the left half of the channel to match the refractive index with PDMS.

As shown in FIGS. 24B and 24C, the index matched area projects the image behind it with minimal obstruction. The quality of the test sample in terms of surface finish, homogeneity of the PDMS, and attachment to the substrate can further improve the transparency of the system. Accordingly, dynamic change of a dynamic light control system that simply transmits all sunlight through any desired portion of the DLCS can be provided.

Lastly, as shown in FIG. 24D, in the pigmented liquid-filled condition, the sample is filled with a light absorbing liquid which makes the window appear tinted. Based on the opacity of the liquid used, the sample can either block light entirely or diffuse light.

### Fold, Collapse, Glue, Pop-up Fabrication Method

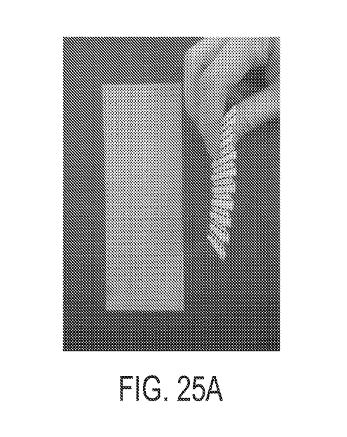

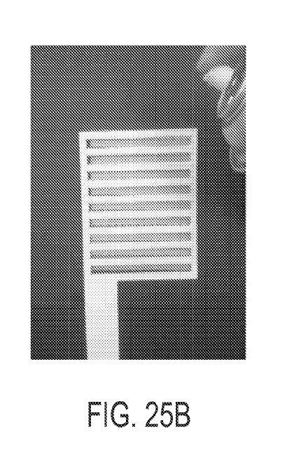

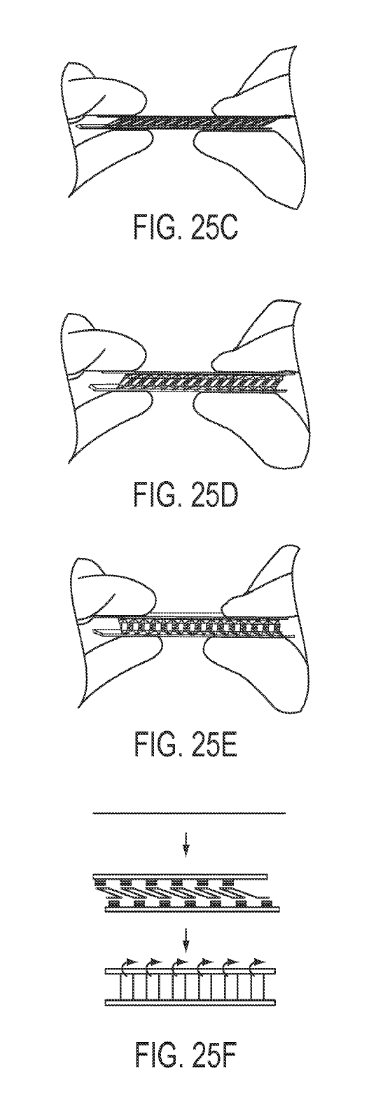

FIGS. 25A-25F show another exemplary fabrication method. First, polyethylene sheets are laser cut and folded as shown in FIG. 25A. Then, as shown in FIG. 25B, selected areas of the laser cut and folded sheets were spray glued. Then, the panes were attached thereto as shown in FIG. 25C. Movement was then adjusted in FIG. 25D and the DLCS pops-up into the structure shown in FIG. 25E. This is schematically illustrated in FIG. 25F.

Based on these experiments and tests, the key advantages of DLCS, compared with other conventional daylight control systems are simplicity, adjustability, multi-functionality and versatile application potential. Since the DLCS system includes a single homogenous and elastic material layer sandwiched between two panes of glass, manufacturing is simplified and no mechanical hinges are necessary for the actuation. This simplicity also allows the system to be both integrated into a new window system construction, as well as retrofitted into an existing window system. Shearing the system can be achieved and a wide range of redirection angles can be achieved with fractional amount of shearing distance. Various types of liquid (index matching liquid, suspended or pigmented liquid, etc.) can be utilized in the system based on the requirement to achieve a wide range of daylight control (transmission, redirection, shading, and diffusion).

### Applications

Numerous different applications can be envisioned with the dynamic light control system described herein.

For example, dynamic total reflection based dynamic light control system or dynamic diffuse daylight redirection system with dynamic visual transmittance (can turn from a transparent to opaque state, shading device, privacy) can be envisioned.

The dynamic daylight redirection system can be utilized for aesthetics purposes. For example, the light direction system can be made totally invisible which is currently impossible for any of the competing technologies.

In other embodiments, dynamic thermal control system, allowing temperature control of the glass, can be fabricated.

In other embodiments, overlayer on photovoltaics in order to increase the efficiency of the PV cells (for redirecting light and for cooling) can be fabricated.

In yet other embodiments, sleek simple construction that can be attached as additional layer to any glazing system (cost effective retrofit) can be fabricated.

In yet other embodiments, the dynamic light control system can be built as part of a window, or integrated or retrofitted to existing windows. Dynamic light control system described herein can be attached to the entire or any desired portion of a window. For example, dynamic light control system can be attached to top portion of the window. Many different designs can be contemplated.

In certain embodiments, the dynamic light control system can be utilized as part of a room divider where different parts of room that require differing amounts of illumination can be provided using the dynamic light control system described herein.

Upon review of the description and embodiments provided herein, those skilled in the art will understand that modifications and equivalent substitutions may be performed in carrying out the invention without departing from the essence of the invention. Thus, the invention is not meant to be limiting by the embodiments described explicitly above.

What is claimed is:

1. A dynamic light control system, comprising:
two or more confinement panes;
one or more light redirecting elements positioned between said two or more confinement panes, wherein said light redirecting elements comprise a deformable material; and
one or more fluidic channels formed between said plurality of light redirecting elements and said two or more confining panes;
wherein said one or more light redirecting elements are arranged to deform relative to the position of said two or more confinement panes in response to one or more stimuli to allow redirection of light.

2. The dynamic light control system of claim 1, further comprising a fluid flow mechanism capable of inputting and removing fluid into and out of said one or more fluidic channels.

3. The dynamic light control system of claim 1, wherein said one or more light redirecting elements are transparent in the bulk state.

4. The dynamic light control system of claim 1, wherein said one or more light redirecting elements have an index of refraction that is about 1.2 to about 1.8.

5. The dynamic light control system of claim 1, wherein the thickness of the light redirecting elements ranges from about 10 μm to about 2 mm.

6. The dynamic light control system of claim 5, wherein the aspect ratio of the light redirecting elements range from about 1 to 20.

7. The dynamic light control system of claim 1, wherein the light redirecting elements are shaped and arranged to function as a light reflector.

8. The dynamic light control system of claim 1, wherein the light redirecting elements are shaped and arranged to function as a waveguide.

9. The dynamic light control system of claim 1, wherein the light redirecting elements are shaped and arranged to function as a light scatterer or diffuser.

10. The dynamic light control system of claim 1, wherein said one or more fluidic channels comprises a fluid.

11. The dynamic light control system of claim 10, wherein the fluid is a liquid.

12. The dynamic light control system of claim 10, wherein the fluid is a gas.

13. The dynamic light control system of claim 10, wherein the fluid has an index of refraction that is about the same as the index of refraction of the light redirecting elements.

14. The dynamic light control system of claim 10, wherein the fluid comprises scattering centers, coloring agents, absorbers, reflectors, or combinations thereof.

15. The dynamic light control system of claim 1, wherein said confinement panes are selected from at least one of a glazing pane, a transparent pane, a translucent pane, a non-transparent pane having one or more transparent or translucent regions, or a pane having one or more cutouts.

16. The dynamic light control system of claim 1, wherein one or more of said confinement panes are arranged to deform in response to said one or more stimuli.

17. The dynamic light control system of claim 2, wherein said fluid flow mechanism comprises a pump, an inlet and an outlet connected to at least a part of said one or more fluidic channels.

18. The dynamic light control system of claim 2, wherein said fluid flow mechanism inputs a fluid into said one or more fluidic channels to deform said one or more light redirecting elements.

19. The dynamic light control system of claim 1, wherein said light redirecting elements comprise two or more regions having different mechanical or optical properties and respond differently to said one or more stimuli.

20. The dynamic light control system of claim 1, wherein said light redirecting elements comprise stimuli-responsive material.

21. A method for redirecting light from a source, the method comprising:
providing two or more confinement panes;
providing one or more light redirecting elements positioned between said two or more confinement panes, wherein said light redirecting elements comprise a deformable material and wherein one or more fluidic channels are formed between said one or more light redirecting elements and said two or more confinement panes; and
deforming said one or more light redirecting elements relative to the two or more confinement panes to redirect light.

22. The method of claim 21, wherein said plurality of light redirecting elements are transparent in the bulk state.

23. The method of claim 21, wherein said plurality of light redirecting elements have an index of refraction that is about 1.2 to about 1.8.

24. The method of claim 21, wherein the thickness of the light redirecting elements range from about 10 μm to about 2 mm.

25. The method of claim 25, wherein the aspect ratio of the light redirecting elements range from about 1 to 20.

26. The method of claim 21, wherein the light redirecting elements are shaped and arranged to function as a light reflector.

27. The method of claim 21, wherein the light redirecting elements are shaped and arranged to
function as a waveguide.

28. The method of claim 21, wherein the light redirecting elements are shaped and arranged to function as a light scatterer or diffuser.

29. The method of claim 21, further comprising inputting or removing a fluid into or out of said one or more fluidic channels.

30. The method of claim 29, wherein the fluid is a liquid.

31. The method of claim 29, wherein the fluid is a gas.

32. The method of claim 29, wherein the fluid has an index of refraction that is about the same as the index of refraction of the light redirecting elements.

33. The method of claim 29, wherein the fluid comprises scattering centers, coloring agents, absorbers, reflectors, or combinations thereof.

34. The method of claim 21, wherein said confinement panes are selected from at least one of a glazing pane, a transparent pane, translucent pane, a non-transparent pane having one or more transparent or translucent regions, or a pane having one or more cutouts.

35. The method of claim 29, further comprising deforming one or more of said confinement panes.

36. The method claim 29, wherein said inputting provides said fluid through an inlet port using a pump and said removing removes said fluid through an outlet port.

37. The method of claim 29, further comprising deforming one or more of said one or more light redirecting elements.

38. The method of claim 21, wherein said light redirecting elements comprise two or more regions having different mechanical or optical properties and respond differently to said one or more stimuli.

39. The method of claim 21, wherein said light redirecting elements comprise a stimuli-responsive material.

40. A method of producing a dynamic light control system, the method comprising:
providing two or more confinement panes;
providing one or more light redirecting elements between said two or more confinement panes to form one or more fluidic channels between said one or more light redirecting elements, wherein said light redirecting elements comprise a deformable material; and
arranging said one or more light redirecting elements to deform relative to the position of said two or more confinement panes in response to one or more stimuli to account for a change in the direction of the incident light.

41. The method of claim 40, wherein said plurality of light redirecting elements are transparent in the bulk state.

42. The method of claim 40, wherein said plurality of light redirecting elements have an index of refraction that is about 1.2 to about 1.8.

43. The method of claim 40, wherein the thickness of the light redirecting elements range from about 10 μm to about 2 mm.

44. The method of claim 43, wherein the aspect ratio of the light redirecting elements range from about 1 to 20.

45. The method of claim 40, wherein said providing a plurality of light redirecting elements includes shaping and arranging said plurality of light redirecting elements to function as a light reflector.

46. The method of claim 40, wherein said providing a plurality of light redirecting elements includes shaping and arranging said plurality of light redirecting elements to function as a waveguide.

47. The method of claim 40, wherein said providing a plurality of light redirecting elements includes shaping and arranging said plurality of light redirecting elements to function as a light scatterer or diffuser.

48. The method of claim 40, wherein said light redirecting elements comprise two or more regions having different mechanical or optical properties and respond differently to said one or more stimuli.

49. The method of claim 40, wherein said light redirecting elements comprise a stimuli-responsive material.
